(19) United States
(12) Patent Application Publication
(10) Pub. No.: US 2026/0289636 A1
(43) Pub. Date: Sep. 24, 2026

(54) SYSTEM

(71) Applicant: SoftBank Group Corp., Tokyo (JP)

(72) Inventor: Masanori KATSUBE, Tokyo (JP)

(73) Assignee: SoftBank Group Corp., Tokyo (JP)

(21) Appl. No.: 19/565,592

(22) Filed: Mar. 13, 2026

(30) Foreign Application Priority Data
Mar. 19, 2025 (JP) 2025-045042

(51) Int. Cl. G06Q 30/0601; G06F 16/34; G06F 40/30

(52) U.S. Cl. CPC G06Q 30/0631; G06F 16/345; G06F 40/30

(57) ABSTRACT

A system includes a processor that is configured to collect history information of a user, generate a prompt, based on the collected history information, for instructing a generative AI model to select products having high relevance to the user, and cause the generative AI model to select, based on the prompt, the products having the high relevance to the user.

### CROSS-REFERENCE TO RELATED APPLICATION

This application is based on and claims priority under 35 USC 119 from Japanese Patent Application No. 2025-045042 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional recommendation systems that rely on fixed rules or simple collaborative filtering often fail to generate recommendations that are sufficiently tailored to an individual user's actual interests. In particular, such systems typically do not fully utilize rich user history information, such as detailed search history and purchase history, to instruct a generative AI model in a precise and context-aware manner. As a result, the relevance of recommended products to the user is limited, and the user experience in terms of discovering products of genuine interest is degraded. Furthermore, even when generative AI models are employed, conventional systems often lack a mechanism for generating appropriate prompts for the generative AI models based on user-specific history information, and also lack a mechanism for organizing and presenting AI-selected products in a visually intuitive interface that reflects the user's interests. Therefore, there is a need for a system that can effectively collect and analyze user history information, generate suitable prompts for a generative AI model, cause the generative AI model to select highly relevant products, and organize and visually present these products to the user in a manner that improves recommendation accuracy and usability.

### SUMMARY

In order to solve the above-described problems, according to one aspect of the present invention, there is provided a system comprising a processor, wherein the processor is configured to collect history information of a user, generate a prompt, based on the collected history information, for instructing a generative AI model to select products having high relevance to the user, and cause the generative AI model to select, based on the prompt, the products having the high relevance to the user. In one embodiment, the processor is configured to analyze a search history and a purchase history of the user and generate the prompt for instructing the generative AI model to select the products having the high relevance to the user. In another embodiment, the processor is configured to organize the products selected by the generative AI model based on an interest of the user and provide an interface for visually presenting the organized products to the user. By these means, the system utilizes user-specific history information to generate effective prompts for the generative AI model, enables the generative AI model to select products that are highly relevant to the user, and presents those products in an organized and visually intuitive manner, thereby improving the precision and usability of product recommendation.

The term “system” refers to an arrangement of one or more hardware and software components that cooperatively perform the functions described in the present disclosure, including at least one processor configured as recited in the claims.

The term “processor” refers to one or more processing circuits, such as a central processing unit (CPU), a graphics processing unit (GPU), a digital signal processor (DSP), a microcontroller, or any combination thereof, that executes instructions stored in a memory to perform the operations described in the present disclosure.

The term “user” refers to a person or entity that operates a client device or otherwise interacts with the system, whose behavior, including search actions and purchasing actions, gives rise to history information used by the system.

The term “history information” refers to information indicative of past behavior of the user, including at least search history and purchase history of the user, and optionally further including browsing history, click history, and other interaction logs.

The term “search history” refers to information representing one or more search queries or keywords that have been input or otherwise issued by the user to a search function or search service over time.

The term “purchase history” refers to information representing one or more products or services that have been purchased or otherwise acquired by the user, including product identifiers, purchase timestamps, quantities, and transaction-related details.

The term “generative AI model” refers to a machine learning model, such as a neural network-based generative model or a large language model, that generates or outputs data, such as product selections or scores, in response to input data including prompts, and that is capable of inferring relationships or preferences not explicitly encoded by fixed rules.

The term “prompt” refers to data, including text or structured information, that is generated by the processor based on the history information of the user and that is provided as input to the generative AI model to instruct the generative AI model to perform a specific task, such as selecting products having high relevance to the user.

The term “products having high relevance to the user” refers to products that the generative AI model determines to have a high likelihood of matching the user's interests or preferences, as inferred from the user's history information and the prompt, relative to other products in a catalog or dataset.

The term “select” refers to the act of identifying, from among a plurality of candidate products, one or more products that satisfy a condition, such as having high relevance to the user, and outputting data indicative of those products.

The term “organize” refers to arranging or structuring the products selected by the generative AI model according to one or more criteria related to the user's interests, such as category, brand, price range, or relevance score, for presentation to the user.

The term “interface” refers to a software and/or hardware component that provides a user-accessible presentation layer, such as a graphical user interface on a display device, through which the products selected and organized by the system are visually presented to the user and optionally made selectable or actionable.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

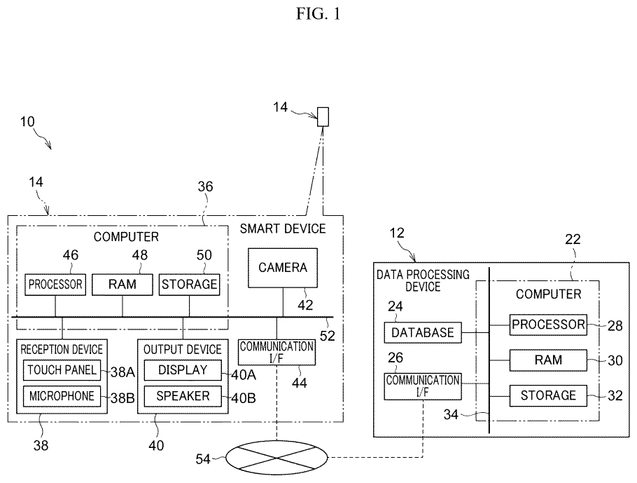

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

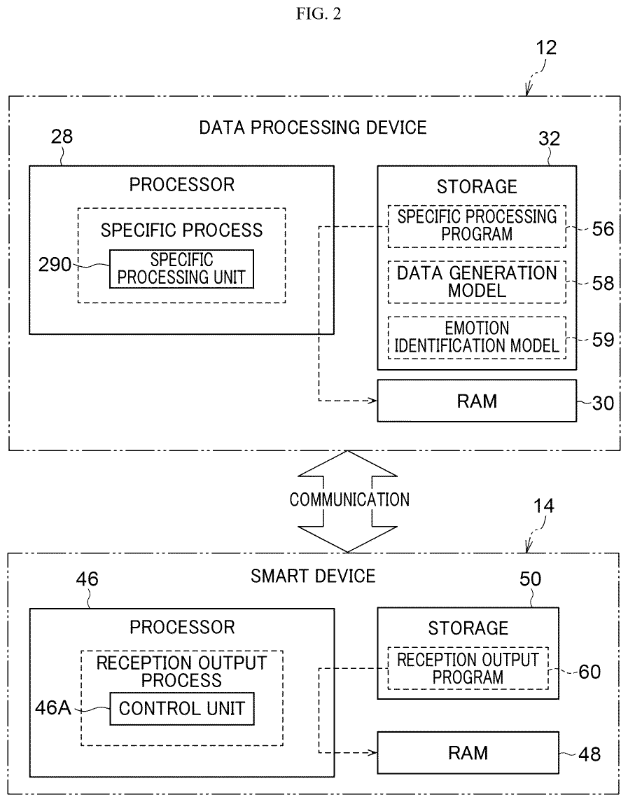

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional recommendation systems in networked commerce and content platforms often rely on fixed scoring rules, manually designed feature engineering, or narrowly trained machine learning models. These systems typically process user search history and transaction history using rigid algorithms that do not flexibly adapt to nuanced behavioral patterns, and they frequently require separate, complex pipelines to construct queries or feature vectors for downstream recommendation engines. As a result, such systems can suffer from low recommendation accuracy, high engineering overhead, and difficulty in maintaining or extending the logic as the catalog or user behavior evolves.

Furthermore, when generative AI models are employed, known approaches usually provide only coarse, static prompts that do not systematically encode detailed user history, selection constraints, or output format requirements. This can cause instability in the generated results, such as inclusion of items that are not present in the catalog, lack of alignment with the user's actual interests, and output formats that are not directly machine-consumable. Additional ad hoc post-processing logic is then required, which increases latency and resource consumption on computer systems.

In addition, existing systems often do not tightly integrate the generative AI model output with a structured catalog lookup process. The mapping from generated textual suggestions to concrete catalog entries is typically performed in an ad hoc manner, which can result in inconsistent item resolution, redundant or unavailable items, and inefficient use of storage and processing resources. These inefficiencies degrade the quality and stability of recommendation interfaces and increase the computational burden on servers, storage subsystems, and communication networks.

Accordingly, there is a need for a computer-implemented technique that programmatically constructs rich, machine-readable prompt sentences from user behavioral history, interacts with a generative AI model under explicit constraints, and deterministically reconciles the AI output with catalog data. Such a technique should improve the efficiency, reproducibility, and scalability of recommendation processing, thereby enhancing the operation of the underlying computer system itself, including processor utilization, memory access patterns, and data flow between storage and network interfaces.

The specific processing by the specific processing unit 290 of the data processing device 12 in Example 1 is realized by the following means.

The present invention provides a server comprising a processor configured to acquire behavioral history information of a user, including search history information and transaction history information, store the behavioral history information as recorded information in a storage medium, programmatically generate, from the recorded information, a structured prompt sentence that includes a natural-language summary of selected history, explicit conditions on a number of recommendation targets, and a specified output data format for a generative AI model, transmit the structured prompt sentence to the generative AI model, receive machine-readable recommendation target candidates generated by the generative AI model based on the structured prompt sentence, resolve the recommendation target candidates against a catalog data store to obtain concrete item identification information, price information, and image information, integrate the resolved data as recommendation target information with associated relevance indicators or explanatory information, and control transmission of the recommendation target information to a user display device together with ranking information for ordered display. This enables an improvement in computer functionality by transforming unstructured user behavioral history into a constrained, machine-optimized prompt for a generative AI model, reducing ambiguities in AI output, minimizing post-processing overhead, and providing a deterministic, catalog-aware recommendation pipeline that yields more accurate, stable, and efficient recommendation processing on the server, storage, and network resources.

The term “processor” refers to a hardware or virtualized computation resource, such as a central processing unit or processing core, that executes program instructions to perform data acquisition, data processing, communication control, and storage operations.

The term “system” refers to an arrangement including at least the processor, one or more storage media, and one or more communication interfaces, configured to execute the functions defined in the claims as an integrated computational environment.

The term “information processing apparatus” refers to electronic equipment, including a server device or networked computing device, that performs automated data processing under control of the processor.

The term “behavioral history information” refers to electronic records representing past actions of a user, including but not limited to search operations, browsing activities, selection operations, and transaction operations performed via an electronic interface.

The term “recorded information” refers to data derived from behavioral history information that has been stored in a storage medium in association with identifiers, timestamps, or other metadata enabling retrieval and analysis.

The term “search history information” refers to a subset of behavioral history information representing queries, keywords, or search input strings issued by the user through a search interface of an electronic service.

The term “transaction history information” refers to a subset of behavioral history information representing completed or attempted purchase operations, order operations, or other commercial transactions associated with items or services.

The term “natural-language description” refers to text expressed in a human language that summarizes or explains behavioral history information in a linguistically coherent form suitable for interpretation by a generative AI model.

The term “prompt sentence” refers to a structured text, including the natural-language description and one or more explicit instructions or constraints, that is provided as input to a generative AI model to cause the model to perform a specified generation task.

The term “output format” refers to a specification, included in the prompt sentence, that defines a structural layout of the generative AI model output, such as a machine-readable data structure, field names, or syntax requirements.

The term “processing conditions” refers to parameters or constraints, included in the prompt sentence, that control behavior of the generative AI model, including conditions on a number of recommendation targets, categories, or other generation rules.

The term “generative AI model” refers to a computational model, such as a neural network-based language model, configured to generate text or structured data in response to input text, including the prompt sentence.

The term “recommendation target candidate” refers to an item, entity, or concept proposed by the generative AI model as a potential recommendation based on the prompt sentence and the behavioral history information.

The term “generation result” refers to data output from the generative AI model in response to the prompt sentence, including a plurality of recommendation target candidates and any associated descriptive information.

The term “merchandise information recording medium” refers to a storage medium, such as a database or indexed data store, that holds catalog information for items or services, including identifiers, attributes, pricing data, and media data.

The term “name information” refers to textual data representing a designation, label, or title of a recommendation target candidate or catalog item.

The term “attribute information” refers to data describing characteristics of an item or recommendation target candidate, including category, brand, specification, or other descriptive properties.

The term “item identification information” refers to data uniquely identifying a catalog item, such as a product identifier, stock keeping unit code, or other unique key.

The term “price information” refers to data representing a monetary value associated with an item, including a sale price, list price, or currency representation.

The term “image information” refers to data specifying visual media associated with an item, including image files, image identifiers, or references to image resources.

The term “recommendation target information” refers to a structured aggregation of data for each recommendation target candidate, including item identification information, price information, image information, and optionally explanatory or ranking data.

The term “user display device” refers to an electronic display apparatus, such as a terminal device, that outputs visual information to the user under control of the processor.

The term “visual interface” refers to a presentation of information on the user display device, including graphical elements, text elements, and layout structures used to show recommendation target information.

The term “condition regarding a number of recommendation targets” refers to a constraint included in the prompt sentence that specifies a minimum, maximum, or exact count of recommendation target candidates to be generated by the generative AI model.

The term “output data format” refers to a formal specification, included in the prompt sentence, that defines how the generative AI model structures the generated data, including field names, nesting, list structures, or serialization style.

The term “relevance indicator” refers to quantitative or qualitative data expressing a degree of relevance between a recommendation target candidate and the user's behavioral history information.

The term “explanatory information” refers to descriptive text or data explaining why a recommendation target candidate is proposed for the user, based on behavioral history information or other factors.

The term “ranking” refers to an ordering of recommendation target information based on the relevance indicator or related criteria, specifying a priority or display order among multiple recommendation targets.

The term “display control” refers to operations executed by the processor to determine how, in what order, and with what emphasis recommendation target information is presented on the user display device.

In one embodiment, a server cooperates with a terminal operated by a user to implement a recommendation system that utilizes a generative AI model. The server is realized as a computing apparatus including at least one processor, a main memory, a non-volatile storage device, and a network interface. The server can be implemented on a general-purpose computer platform, such as a rack-mount server equipped with one or more central processing units, one or more graphics processing units, and a network controller. The terminal is implemented as a client device such as a smartphone, tablet, or personal computer including a display, an input interface, a memory, and a communication unit. The user operates the terminal to issue search queries, browse items, and execute transactions.

The server executes a program that is stored in the non-volatile storage device and loaded into the main memory. The program is implemented using a server-side framework such as an application framework and exposes an application programming interface through the network interface. The server uses a relational database management system, such as a general-purpose structured query language database, as a storage medium to persist behavioral history information. The server further uses an additional storage medium, such as a catalog database or search index, to store merchandise information including item identifiers, attributes, and images.

The server acquires behavioral history information of the user by receiving data transmitted from the terminal. The behavioral history information includes search history information (keywords, search strings, query timestamps) and transaction history information (item identifiers, quantities, transaction timestamps, and status codes). The server stores the behavioral history information as recorded information in one or more database tables. For example, the server stores search history information in a search history table including fields such as user identifier, search keyword, timestamp, device type, and locale, and stores transaction history information in a transaction history table including fields such as user identifier, item identifier, order identifier, timestamp, and payment status.

The server uses a data access layer, such as an object-relational mapping component, to retrieve and aggregate the recorded information from the database. The server selects particular history records based on pre-defined selection criteria, such as a limited time range, a maximum number of recent events, or weights assigned to specific event types. The server normalizes the selected records by performing data processing operations such as lowercasing strings, removing stop words from search queries, mapping item identifiers to canonical catalog identifiers, and converting timestamps to a common time zone. By standardizing data at this stage, the server reduces the dimensionality and complexity of subsequent processing, which improves cache locality and reduces the number of disk accesses for repeated computations.

The server converts the normalized history records into a natural-language description. For example, the server generates a textual summary that concatenates multiple search queries and purchased items in a grammatically coherent sentence. The server may generate a description such as: “The user's search history contains: ‘outdoor jacket’, ‘rainwear’. The user's purchase history contains: ‘trekking shoes’, ‘hiking socks’.”

The server then constructs a prompt sentence for a generative AI model by combining the natural-language description with explicit processing conditions and an output format specification. The server composes a multi-part text in which a first part is the history summary, a second part specifies the number of items to be generated, and a third part specifies the desired structure of the output. For example, the server can construct a prompt sentence such as:
“The user's search history contains: ‘outdoor jacket’, ‘rainwear’. The user's purchase history contains: ‘trekking shoes’, ‘hiking socks’. Based on this history, use a generative AI model to generate a list of at least 5 highly relevant recommended products. For each product, provide a short reason. Return the result as JSON-like text with fields named ‘product_name’ and ‘reason’ and do not include any other fields.”

In another example, the server can construct a prompt sentence that introduces category constraints and format constraints:
“The user frequently searches for ‘trail running shoes’and ‘hydration pack’ and has purchased ‘running shorts’ and ‘compression tights’. Based on this information, use a generative AI model to propose at least 5 and at most 8 products from the outdoor running category only. Provide concise reasons for each recommendation. Return the result as a numbered list in plain text, where each line contains a product name followed by a colon and a reason.”

The server transmits the constructed prompt sentence to the generative AI model through a network connection. The generative AI model is hosted on a machine-learning inference server that includes at least one graphics processing unit. In one embodiment, the generative AI model is implemented as a transformer-based neural network that uses multiple self-attention layers, feed-forward layers, and embedding layers. The model is trained on large-scale text data and fine-tuned on domain-specific data that includes product descriptions, user reviews, and historical recommendation logs.

The server and the generative AI model cooperate in a way that improves computer technology beyond mere automation of human decision-making. The server encodes detailed output format constraints and item-count constraints in the prompt sentence, which causes the generative AI model to generate output that is structurally aligned with downstream parsing and catalog-matching logic. As a result, the server can avoid complex natural-language post-processing steps that would otherwise be necessary. This reduces CPU time spent on string parsing and error correction, decreases memory consumption by eliminating intermediate conversion buffers, and lowers network traffic by avoiding multiple correction cycles between the server and the inference backend.

The generative AI model processes the prompt sentence by tokenizing the text into subword units, mapping each token to a vector representation through an embedding matrix, and propagating the embedded sequence through multiple transformer blocks. Each transformer block performs operations such as scaled dot-product attention, layer normalization, and position-wise feed-forward operations. During inference, the model uses a decoding strategy, such as greedy decoding or top-k sampling, to sequentially generate a textual output that lists recommendation target candidates and associated explanations. Because the input prompt sentence includes explicit rules for field names and structural constraints, the model learns, during training and fine-tuning, to respect such constraints. This yields outputs that are more consistent and easier to parse, which directly improves system throughput and reduces error rates in downstream modules.

The server receives the output of the generative AI model as a textual sequence and performs syntactic and semantic validation. The server uses a parser that looks for expected structural patterns, such as numbered lists or consistent separators. The server extracts product name phrases and associated explanatory phrases. Because the prompt sentence explicitly conditioned the model on a fixed output structure, the parsing process is simplified to operations such as splitting lines and separating product names from reasons based on predetermined delimiters. This design reduces the computational complexity of the parsing step and minimizes misalignment between AI output and catalog identifiers, which in turn decreases the need for costly fallback mechanisms such as manual review or repeated AI calls.

The server uses the product name phrases or attribute phrases extracted from the generative AI output as query terms for a catalog data store. The server performs search operations on the merchandise information recording medium using an indexed search engine. The server computes similarity scores between the phrases and stored product names or descriptions using ranking functions such as term frequency and inverse document frequency or vector-based embedding similarity. In some embodiments, the server pre-computes vector embeddings for product titles and descriptions using an encoder network and stores these embeddings in a vector index. The server then obtains candidate catalog items whose embeddings are within a threshold distance of the embedding of the generated product name. This vector-based retrieval method reduces the number of false matches and enables the server to robustly map slightly varied generated texts to concrete catalog entries.

The server collects catalog records that match the AI-generated candidates and constructs recommendation target information for each matched item. The recommendation target information includes item identification information, price information, image information, and explanatory information that originates from the generative AI model. The server may also assign a relevance indicator to each recommendation target, which is computed based on factors such as similarity scores, recency of user interactions, and ranking hints present in the generative AI output. This multi-factor ranking allows the server to prioritize items that are both semantically relevant and operationally suitable (in-stock, available in the user's region, etc.), thereby reducing the chance of presenting invalid or low-value recommendations.

The server transmits the finalized recommendation target information to the terminal. The recommendation target information is formatted as structured data and may include ordering or grouping metadata. The terminal receives this data through its communication module, stores it temporarily in memory, and renders it on a display. The terminal uses a graphical user interface library to display item images, names, prices, and explanatory text in an ordered list or grid. The terminal may also implement user interaction elements such as buttons for viewing details or initiating a transaction. The user can visually inspect the recommendations and interact with them, which generates further behavioral history that the server can ingest.

By using the described data structures and processing pipeline, the server improves the operation of the computer system in several ways. First, by generating prompt sentences that embed precise structural constraints and selection conditions, the server causes the generative AI model to output data that is directly consumable by downstream modules. This reduces the need for complex post-processing algorithms and decreases the average processing time per recommendation request. Second, by performing catalog-aware resolution and ranking, the server ensures that a majority of the generated candidates correspond to valid catalog items, reducing wasted catalog queries and network bandwidth. Third, by pre-normalizing behavioral history information and by applying vector-based retrieval techniques, the server increases the accuracy and stability of the mapping from free-form AI output to concrete items, which improves user experience and reduces error-correction cycles.

The server uses a trained neural network model as the generative AI model. During training, the model is provided with prompt sentences that include user history summaries, constraints on the number of recommendations, and explicit instructions on output structure, along with target outputs that consist of correctly formatted recommendation lists linked to catalog items. The training process uses a loss function such as cross-entropy over the token sequence, optionally combined with auxiliary losses that penalize violations of structural rules (for example, missing field names or incorrect delimiters). The model's parameters are updated by an optimization algorithm such as stochastic gradient descent with adaptive learning rates. Training data may be augmented by permuting the order of items, paraphrasing history summaries, or injecting synthetic constraints, which improves the model's robustness to variations in prompt sentences.

In another embodiment, the server uses a two-stage neural architecture, in which a first model encodes the behavioral history information into a compact vector representation, and a second generative model produces textual recommendations conditioned on the encoded vector and on prompt sentence text. The encoding model may be trained to emphasize specific types of features, such as item categories, temporal patterns, or co-purchase correlations, thereby compressing large behavioral datasets into a low-dimensional representation that is efficiently processed by the generative decoder. This design reduces the memory footprint and computation time during inference by limiting the length and complexity of input sequences processed by the generative model.

The server, the terminal, and the user cooperate in various possible configurations. In one variation, the server executes multiple generative AI models with different capacity or specialization levels and selects a particular model based on the amount of available behavioral history, current system load, or latency requirements. For users with limited history, the server may use a smaller model with a shorter context window to minimize response time. For users with rich histories or when latency constraints are relaxed, the server may use a larger model with more layers and a longer context window to capture subtler preference patterns. In another variation, the server periodically pre-computes recommendation target information for active users and caches the results in a high-speed memory store, updating the cache when new significant events occur. This strategy reduces peak-time inference load and network congestion by serving many requests from cache.

The system provides a technical effect in that the server changes the way in which the computing platform processes and manages behavioral data and AI-generated text. Instead of executing a straightforward business-rule-based filtering engine, the server implements a structured prompt generation mechanism, a model-constrained output generation process, and a deterministic catalog resolution pipeline. These components cooperate to improve computational efficiency, reduce errors caused by unstructured AI output, and optimize storage and network utilization. Because the generative AI model is steered by machine-designed prompt sentences that capture detailed structural and numerical constraints, the computer performs an operation that is not a simple automation of human curation but an improvement of the internal data flow and algorithmic structure of the recommendation engine itself.

The described embodiments are illustrative, and the server, the terminal, and the user can participate in additional or alternative configurations without departing from the scope of the claimed invention. For example, the server can employ different relational or non-relational databases, different neural network architectures such as encoder-decoder models or mixture-of-experts models, and different prompt sentence templates tailored for specific domains such as media content, services, or industrial parts. The terminal can be realized as a head-mounted display or vehicle-mounted apparatus. These variations still rely on the core mechanism in which the server generates constraint-rich prompt sentences, uses a generative AI model to produce structured, machine-usable recommendation target candidates, and resolves those candidates to concrete catalog entries in a technically efficient manner.

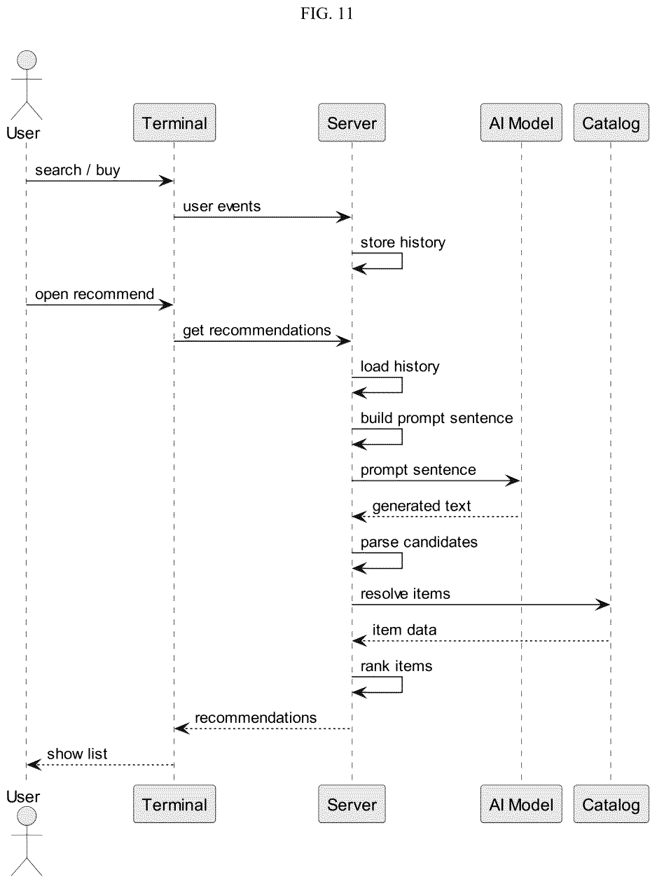

The following describes the processing flow using FIG. 11.

### Step 1:

The user operates the terminal to perform actions such as entering search queries and purchasing items.

The input is user interaction data, including text typed into a search box (for example, “outdoor jacket”) and selection operations on product listings (for example, tapping a “Buy” button).

The terminal detects these interactions via its user interface components, converts them into structured event records containing fields such as user identifier, event type, keyword or item identifier, timestamp, and device type, and stores the records temporarily in local memory.

The output is one or more event records ready to be transmitted to the server.

### Step 2:

The terminal transmits the event records to the server over a network.

The input is the structured event records generated in Step 1.

The terminal packages the event records into request messages, for example as HTTP requests with a message body encoded in a structured text format, and sends them via a communication module to a predefined server endpoint. The terminal also adds authentication tokens or session identifiers to the message headers.

The output is one or more network messages containing the user's behavioral history data delivered to the server.

### Step 3:

The server receives and stores the behavioral history information in a storage medium.

The input is the network messages containing event records transmitted by the terminal in Step 2.

The server parses the messages, validates required fields (such as user identifier and event type), normalizes textual fields (such as converting keywords to lowercase and trimming whitespace), converts timestamps to a unified time zone, and maps item identifiers to canonical catalog identifiers. The server then writes the normalized data to database tables for search history and transaction history using data manipulation commands.

The output is recorded information stored in the database, including normalized search history information and transaction history information associated with the user.

### Step 4:

The server retrieves and aggregates the recorded information for recommendation processing.

The input is the recorded information stored in the database in Step 3, selected according to a target user identifier.

The server executes retrieval commands to obtain recent search queries and recent transactions, applies selection criteria such as time windows and maximum record counts, and aggregates the results into in-memory data structures ordered by timestamp or importance. The server may also compute simple statistics, such as counts per category or frequency of specific keywords.

The output is an aggregated behavior profile for the user, including a list of normalized search history entries and a list of transaction history entries.

### Step 5:

The server generates a natural-language description from the aggregated behavioral history.

The input is the aggregated behavior profile produced in Step 4.

The server selects representative search terms and catalog item names, groups them by relevance or recency, and formats them into a coherent textual summary using string concatenation and template-based generation. For example, the server may produce text such as: “The user's search history contains: ‘outdoor jacket’, ‘rainwear’. The user's purchase history contains: ‘trekking shoes’, ‘hiking socks’.”

The output is a natural-language description summarizing the user's search history information and transaction history information.

### Step 6:

The server constructs a prompt sentence for the generative AI model.

The input is the natural-language description from Step 5 and predefined generation constraints, such as a desired number of recommendation targets and an output data structure specification.

The server appends instruction clauses to the description, explicitly indicating the task, the number of items to be produced, and the expected output structure. The server concatenates these elements into a single prompt sentence, for example: “The user's search history contains: ‘outdoor jacket’, ‘rainwear’. The user's purchase history contains: ‘trekking shoes’, ‘hiking socks’. Based on this history, use a generative AI model to generate a list of at least 5 highly relevant recommended products. For each product, provide a short reason. Return the result as a list in which each line contains a product name followed by a colon and a reason.”

The output is a fully constructed prompt sentence that encodes both user behavior and explicit constraints for the generative AI model.

### Step 7:

The server transmits the prompt sentence to the generative AI model and requests generation of recommendation target candidates.

The input is the prompt sentence created in Step 6.

The server embeds the prompt sentence into a request payload and sends it to a machine-learning inference server via a communication interface. The server may attach additional parameters such as maximum generation length or decoding strategy. The inference server, which hosts a transformer-based neural network, tokenizes the prompt sentence, maps each token to an embedding vector, and processes the sequence through multiple self-attention and feed-forward layers to compute output probabilities over tokens. The neural network then generates output text token by token, following the structural and numerical constraints expressed in the prompt sentence.

The output is a generated textual sequence that lists recommendation target candidates and associated explanations in the requested structure.

### Step 8:

The server parses the generative AI model output and extracts recommendation target candidates.

The input is the textual sequence generated by the generative AI model in Step 7.

The server analyzes the text to detect structural delimiters, such as line breaks and colons, splits the text into individual lines or entries, and further separates each entry into a product name component and an explanatory component. The server also performs trimming and normalization on the extracted phrases and discards malformed entries that do not match the expected pattern.

The output is a list of recommendation target candidates represented by product name phrases and associated explanatory phrases.

### Step 9:

The server resolves the recommendation target candidates against a catalog data store.

The input is the list of product name phrases and explanatory phrases obtained in Step 8, together with a catalog containing item records.

The server converts each product name phrase into a query, performs lookup operations on the catalog using text-based search or vector similarity search, and calculates similarity scores between candidate items and the generated phrase. The server selects one or more catalog items for each phrase based on the highest similarity scores and availability constraints (such as stock status and region). The server retrieves item identification information, price information, image information, and other attributes from the catalog.

The output is a set of resolved recommendation targets, each associated with concrete catalog item data and the original explanation.

### Step 10:

The server assigns relevance indicators and ranks the resolved recommendation targets.

The input is the set of resolved recommendation targets from Step 9 and optionally additional behavior-derived metrics.

The server computes a relevance score for each target by combining similarity scores from catalog matching with signals derived from the user's behavioral history, such as recency of interaction and frequency of related searches. The server may use a weighted sum or a learned ranking model to calculate the final score. The server sorts the recommendation targets in descending order of relevance score and attaches the resulting rank position to each target.

The output is an ordered list of recommendation targets with associated relevance indicators and explanatory information.

### Step 11:

The server transmits the ranked recommendation targets to the terminal.

The input is the ordered list of recommendation targets obtained in Step 10.

The server formats the list into a structured representation that includes item identifiers, names, prices, image references, explanations, and rank positions and sends this representation to the terminal over the network. The server may compress the data or batch multiple items into a single response to reduce network overhead.

The output is one or more response messages delivered to the terminal containing the complete recommendation result set.

### Step 12:

The terminal receives and displays the recommendation targets to the user.

The input is the response message from the server transmitted in Step 11.

The terminal parses the received data into internal structures, allocates visual components such as image views and text labels, and arranges the components in a user interface according to the rank positions (for example, showing higher-ranked items at the top of a list). The terminal loads image resources referenced by the received data and renders the images along with item names, prices, and explanatory text on the display. The terminal accepts further user interactions with the displayed items, such as taps or clicks on individual recommendations.

The output is a displayed recommendation list on the terminal and, upon user interaction, new event records that can be sent back to the server as additional behavioral history.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recommendation systems in network-based commerce environments primarily rely on fixed heuristic rules or pre-trained predictive models that operate on pre-aggregated user history data. Such systems typically update recommendations in coarse batches and use manually engineered feature vectors, resulting in several technical problems in computer technology itself. For example, these systems often incur significant latency and computational overhead when re-computing recommendations upon each new user interaction, because they require complex feature extraction pipelines and repeated model inference over large-scale structured datasets. In addition, conventional architectures do not efficiently transform heterogeneous user behavior logs into a representation that can be flexibly consumed by modern generative models, leading to suboptimal utilization of computing resources and memory bandwidth.

Further, existing systems generally treat search history data and purchase history data as separate streams or simple counters, and do not dynamically reformat these streams into compact natural-language instructions that can be processed by a generative AI model in real time. As a result, when a user issues a new query or interacts with recommended content, the underlying computing system is unable to promptly incorporate the latest behavior into the recommendation logic without re-running multiple disjoint processing stages. This causes delays, redundant database access operations, inefficient use of processor caches, and unnecessary network communication between components.

Moreover, many known systems lack an integrated mechanism for iteratively feeding back recommendation viewing events and selection operations from a mobile terminal into a server-side generative pipeline. The absence of such a feedback loop at the system level leads to stale recommendation contexts, inefficient session handling, and fragmented data structures, all of which degrade the overall performance of the computer system in terms of processing throughput, responsiveness of the user interface, and scalability under high concurrent access.

Accordingly, there is a need for an improved computer-implemented system and method that: (i) efficiently acquires and structures user search and purchase history data, (ii) converts such data into compact prompt sentences for a generative AI model, (iii) maps natural-language outputs from the generative AI model back into structured product information, and (iv) continuously updates the prompt sentences based on real-time feedback from a mobile terminal. By addressing these issues, the invention aims to improve the operation of computers themselves, including more efficient use of processor operations, memory structures, and communication resources in generating and delivering real-time personalized recommendations.

The specific processing by the specific processing unit 290 of the data processing device 12 in Application Example 1 is realized by the following means.

The present invention provides a server comprising a processor and at least one storage device, the processor being configured to execute instructions to acquire, from the at least one storage device that stores behavior history information of a user, search history information and purchase history information associated with the user; to convert the acquired search history information and purchase history information into tabular data by executing a data processing program, to perform numerical computation on the tabular data to extract attribute information and preference information relating to the user, and to generate a prompt sentence in a natural language including at least part of the search history information and the purchase history information; to transmit the prompt sentence as input information to a generative AI model provided by an information processing apparatus, and to obtain a generated result in the natural language from the generative AI model, the generated result including a plurality of candidate objects having a high degree of relevance to the user; to compare each of the plurality of candidate objects included in the generated result with product information stored in a product information storage device, to identify product identification information corresponding to each candidate object, to narrow down the plurality of candidate objects based on inventory information and supply condition information, and to generate recommendation product information as structured data; to output, to a communication device, the recommendation product information together with display control information so that a mobile terminal receives the recommendation product information via a communication network and displays the recommendation product information in real time on a display unit of the mobile terminal; and to acquire, from the mobile terminal via the communication device, viewing information and selection operation information relating to the recommendation product information as behavior history information of the user, to sequentially store the acquired viewing information and selection operation information in the at least one storage device, and to update contents of the prompt sentence based on the stored behavior history information so as to repeatedly transmit updated prompt sentences to the generative AI model. This enables an improvement in computer technology by transforming heterogeneous user behavior logs into compact prompt sentences that are efficiently processed by a generative AI model, by converting natural-language outputs into structured recommendation data with reduced computation and memory overhead, and by maintaining a continuous feedback loop between the server and the mobile terminal that dynamically refines recommendations in real time, thereby enhancing processing throughput, lowering latency, and improving the responsiveness and scalability of the underlying computer system.

The term “processor” refers to a hardware execution unit, such as a central processing unit or other programmable processing circuitry, that executes instructions to perform data acquisition, data processing, communication control, and other operations described herein.

The term “storage device” refers to any non-transitory computer-readable medium, such as a magnetic storage, optical storage, semiconductor memory, or a combination thereof, configured to store program code, user behavior history information, product information, and intermediate data structures used by the processor.

The term “behavior history information” refers to digital data representing past activities of a user in an information processing environment, including but not limited to search actions, product viewing actions, selection operations, and purchase actions, each associated with at least a user identifier and time information.

The term “search history information” refers to behavior history information that specifies search queries or search keywords input by a user to an information retrieval function of an application or service.

The term “purchase history information” refers to behavior history information that specifies items or services for which a purchase process by a user has been completed or initiated, including at least identifiers of purchased items and associated transaction information.

The term “tabular data” refers to a structured data format in which multiple records are represented in rows and columns, each column corresponding to an attribute, and each row corresponding to an instance of history or product information, such that the data can be processed by numerical computation and data analysis algorithms.

The term “attribute information” refers to information derived from behavior history information that characterizes properties of a user or of items related to the user, including but not limited to categories, price ranges, brands, and temporal attributes inferred or aggregated by the processor.

The term “preference information” refers to information indicating tendencies or interests of a user inferred from behavior history information, including scores, rankings, or distributions over categories, item types, or attributes computed by the processor.

The term “prompt sentence” refers to a natural-language text sequence generated by the processor that encodes at least part of the search history information and the purchase history information of a user, and that is formatted as an instruction or query to be supplied as input to a generative AI model.

The term “natural language” refers to a human language, such as English or another human-spoken language, represented in machine-readable text format and understandable by a natural-language processing model.

The term “generative AI model” refers to a parameterized information processing model that performs probabilistic or neural-network based generation of text in response to an input sequence, and that is configured to output natural-language content including candidate objects having a high degree of relevance to the user.

The term “information processing apparatus” refers to any computing system, local or remote, that executes the generative AI model and processes the prompt sentence to produce a generated result, and that is communicatively coupled to the processor.

The term “generated result” refers to natural-language output data produced by the generative AI model in response to the prompt sentence, the output data including at least a plurality of candidate objects described in text.

The term “candidate object” refers to an item or item type expressed in the generated result as a natural-language term, phrase, or name, which is deemed potentially suitable for recommendation to the user.

The term “product information” refers to structured data representing attributes of items that are offered through a commerce or information platform, including but not limited to product identifiers, titles, descriptions, prices, images, categories, and availability status.

The term “product information storage device” refers to a storage device or database configured to store product information in an accessible structured form for retrieval and comparison by the processor.

The term “product identification information” refers to data that uniquely or quasi-uniquely identifies a product within the product information storage device, such as a product ID, SKU, or other unique code.

The term “inventory information” refers to data indicating availability status and quantity of products, including stock levels, replenishment data, or sell-out status, as stored in association with product information.

The term “supply condition information” refers to data that constrains or qualifies the ability to provide a product to a user, including but not limited to region restrictions, shipping conditions, pricing rules, or promotional conditions.

The term “recommendation product information” refers to structured data generated by the processor that describes products selected for recommendation to a user, and that includes at least product identification information and associated attributes suitable for display.

The term “structured data” refers to data that is organized according to a predefined schema or format, such as key-value pairs, records, tables, or objects, facilitating deterministic parsing and processing by the processor.

The term “communication device” refers to hardware and associated control logic that provide network communication capabilities, such as a network interface controller, modem, or communication module, configured to transmit and receive data between the server and external devices.

The term “mobile terminal” refers to a portable electronic device, such as a smartphone or tablet computer, that includes at least a display unit, an input interface, a communication interface, and a processor executing an application that interacts with the server.

The term “display control information” refers to data or instructions output by the processor that specify how recommendation product information is to be presented on a display unit of the mobile terminal, including layout information, ordering information, and associated metadata.

The term “display unit” refers to a visual output device included in the mobile terminal, such as a liquid crystal display or organic light-emitting diode panel, that presents images and text to a user.

The term “viewing information” refers to behavior history information indicating how the user has viewed or browsed recommendation product information, including but not limited to impression events, scroll events, dwell times, and exposure positions.

The term “selection operation information” refers to behavior history information indicating explicit operations performed by the user on recommendation product information, including but not limited to tap events, click events, addition-to-cart events, and purchase initiation events.

The term “template sentence” refers to a predefined natural-language sentence pattern that includes one or more placeholders for insertion of keyword information, classification information, or other variable data when generating the prompt sentence.

The term “keyword information” refers to textual tokens or phrases extracted from search history information, purchase history information, or product information that characterize user interests or item attributes and are used to construct the prompt sentence.

The term “classification information” refers to category, type, or group information that classifies products or behaviors into predefined or inferred classes, which is used to summarize user behavior or product attributes within the prompt sentence.

The term “occurrence frequency information” refers to data indicating how often particular keywords, categories, or items appear in behavior history information over a specified period.

The term “novelty information” refers to data indicating relative recency or newness of particular behaviors, items, or categories in behavior history information, for example based on timestamps or first occurrence.

The term “segmentation processing” refers to a process of dividing a natural-language text string into individual tokens, lines, phrases, or segments corresponding to separate candidate object names.

The term “character string analysis processing” refers to operations that analyze text data, including parsing, pattern recognition, normalization, and extraction of candidate object names from the generated result.

The term “similarity calculation processing” refers to computational operations that determine a degree of similarity between textual candidate object names and product information, for example using vector representations, distance metrics, or matching scores, to associate candidate objects with product identification information.

The term “image reference information” refers to data specifying a location or identifier of an image associated with a product, such as a URL, file path, or content identifier, which can be used by a client device to retrieve and display product images.

The term “description information” refers to text data that describes features, usage, or specifications of a product, which is included in recommendation product information for presentation to the user.

In one embodiment, a server, a terminal, and a user cooperate to implement a recommendation system that generates and delivers personalized product recommendations using a generative AI model and structured behavior history information.

The server includes at least one processor, a main memory, a non-transitory storage device, and a communication interface. The server executes an operating system such as a general-purpose server operating system and executes application software implemented, for example, in a high-level programming language such as Python. The server connects to a relational database management system such as a general-purpose relational database, and to a product information database that stores structured product information. The server further accesses a generative AI model executed on an external information processing apparatus via a network such as the Internet.

The terminal includes a processor, a memory, a display unit, a communication interface, and an input interface such as a touch panel. The terminal executes a mobile operating system such as a general-purpose smartphone operating system and executes an application that provides a user interface for search operations, product browsing, and reception of recommendation product information. The terminal communicates with the server via a wireless communication network using standard communication protocols such as HTTP or HTTPS.

The user operates the terminal by viewing screens displayed on the display unit and by performing touch operations through the input interface. The user enters search keywords, scrolls recommendation lists, and selects products. The user's operations are converted into behavior history information and transmitted from the terminal to the server.

In one embodiment, the server uses a data processing program including a data analysis library such as a table-processing library (for example, Pandas) and a numerical computation library (for example, NumPy). The server uses the data analysis library to represent behavior history information as tabular data structures, in which rows correspond to individual behavior events and columns correspond to attributes such as user identifier, item identifier, keyword text, timestamp, and category code. The server uses the numerical computation library to perform vectorized operations for computing occurrence frequencies, recency scores, and preference scores over these attributes. By performing these operations in vectorized form on tabular data, the server reduces the number of separate database queries, increases cache locality, and decreases the number of control instructions executed by the processor, thereby improving processing throughput and reducing latency relative to conventional row-by-row processing.

The server stores behavior history information, including search history information and purchase history information, in the storage device. The behavior history information is stored in multiple tables or collections, such as a search history table and a purchase history table. Each entry includes a user identifier, a textual field (for example, search keyword or product title), a timestamp, and additional metadata such as device type or session identifier.

The server periodically compacts, indexes, and partitions these tables according to user identifier and time ranges so that the amount of data to be read into memory for a request is minimized. This data organization reduces the input/output operations required per recommendation generation and improves overall system scalability.

In one embodiment, the server converts the search history information and the purchase history information into a prompt sentence in a natural language. The server first selects behavior records within a predetermined time window (for example, the most recent N days or the most recent M actions). The server then uses the numerical computation library to compute occurrence frequency information and novelty information for each keyword and for each category, based on the timestamps and categories included in the behavior records. The server selects a subset of keywords and categories that satisfy predetermined criteria, such as having an occurrence frequency above a threshold and a recency score above a threshold. The server concatenates these selected items into text sequences.

The server generates the prompt sentence by inserting the selected text sequences into a template sentence. For example, the server may generate a prompt sentence such as:
User search history: running shoes, trail running, waterproof sneakers
User purchase history: sportswear, running socks
Please generate recommended products that are suitable for a user interested in running and fitness accessories.

By encoding the user's recent behavior as a concise natural-language description, the server compresses a large set of raw log entries into a short text string that can be processed efficiently by the generative AI model. This compression reduces network bandwidth usage between the server and the external information processing apparatus executing the generative AI model, and reduces the amount of pre-processing required on the model side.

In one embodiment, the generative AI model is implemented as a deep neural network having a transformer-type architecture. The generative AI model includes an embedding layer that maps each input token in the prompt sentence to a high-dimensional vector, a plurality of self-attention layers that compute context-dependent representations of the tokens, feed-forward layers that apply non-linear transformations, and an output projection layer that maps the internal representation to a probability distribution over a vocabulary of output tokens.

The generative AI model is trained in advance on large-scale natural-language corpora using a pre-training objective such as next-token prediction or masked-language modeling.

During training, the generative AI model uses an optimization algorithm such as stochastic gradient descent or its variants. The model minimizes a loss function such as cross-entropy loss between the predicted token distribution and the ground-truth token distribution. The model updates its weight parameters by backpropagating the gradient of the loss through all layers, adjusting the attention weights, feed-forward weights, and embedding parameters. The training procedure may incorporate regularization techniques such as dropout, weight decay, or layer normalization, and may use data augmentation such as random masking or token shuffling to improve generalization.

In some embodiments, the generative AI model undergoes fine-tuning using domain-specific data for product descriptions and recommendation scenarios. In such cases, the server or an offline training subsystem prepares training pairs consisting of input prompt sentences (constructed from synthetic or historical user behavior) and target output sequences (consisting of desired product categories and names). The training subsystem uses a similar optimization process to adjust the model weights so that the model outputs more accurate and diverse candidate objects when given prompts in the format generated by the server.

At runtime, the server transmits the prompt sentence to the generative AI model as part of a request message. The request includes the prompt sentence, a maximum output length, a temperature parameter controlling output randomness, and other generation parameters. The information processing apparatus executing the generative AI model uses its processor and memory to perform the forward pass through the neural network, computing attention scores and hidden vectors layer by layer, and ultimately generating a sequence of tokens that form the generated result. The generated result may be a list of product types, product names, or descriptive phrases. For example, in response to the prompt sentence shown above, the generative AI model may output:
Recommended products: running socks, fitness tracker, lightweight running shorts, hydration belt, compression calf sleeves.

The server receives the generated result as natural-language text. The server then applies segmentation processing and character string analysis processing to the generated result.

Specifically, the server splits the generated result by delimiters such as commas, line breaks, or bullet markers, and normalizes the resulting strings by converting case, removing extra whitespace, and optionally applying stemming or lemmatization. The server thus obtains a plurality of candidate object names, each represented as a text string.

The server maps the candidate object names to actual products in the product information storage device. In one embodiment, the server computes vector representations of the candidate object names and of product titles or tags using a text embedding model such as a word embedding or sentence embedding model. The server uses the numerical computation library to calculate similarity scores, such as cosine similarity or inner product, between each candidate object name vector and each product vector in a filtered subset of the product catalog. The server selects, for each candidate object name, one or more products whose similarity score exceeds a threshold. The server may also use auxiliary rules, such as matching category codes or price ranges, to improve mapping precision.

By performing this similarity calculation on vector representations stored in dense numerical arrays, the server leverages efficient linear algebra operations and batch processing on the processor, thereby reducing the number of string comparison operations and improving overall performance and scalability. The use of vector-based similarity rather than simple keyword matching also reduces errors caused by variations in wording, abbreviations, or synonyms.

The server narrows down the mapped products by using inventory information and supply condition information. The server reads stock levels and regional availability flags from the product information storage device and filters out products that are out of stock or unavailable to the user's region. The server may also apply constraints such as maximum number of recommendations or diversity of categories. The server then constructs recommendation product information as structured data, which includes at least product identification information, price information, image reference information, and description information.

The server packages the recommendation product information together with display control information specifying an ordering, grouping, or layout configuration for the terminal's user interface. The server sends this data to the terminal through the communication interface using a network protocol. The terminal receives the recommendation product information, decodes the structured data, and updates the display unit to present a list or grid of recommended products. The terminal may render product images by retrieving image resources indicated by the image reference information.

The user views the displayed recommendation product information on the display unit and may scroll through the list or select particular products. The terminal records viewing information such as which items were visible on screen and for how long, and selection operation information such as which items were tapped or added to a cart. The terminal sends this viewing information and selection operation information back to the server as part of the behavior history information.

The server stores the newly received viewing information and selection operation information in the storage device as additional behavior history data. The server then updates the attribute information and preference information associated with the user by recomputing occurrence frequency information and novelty information using the numerical computation library. For example, when the user repeatedly selects items related to “trail running,” the server increases the preference scores for the related categories and reduces the scores for unrelated categories. The server reflects these updated scores when selecting keywords and categories for the next prompt sentence. As a result, subsequent prompt sentences emphasize the user's latest interests, such as:
User search history: running shoes, trail running
User purchase history: sportswear, running socks
Recent interactions: viewed trail running shoes, selected hydration belt
Please generate recommended products focusing on trail running equipment and related accessories.

Because the server repeatedly updates the prompt sentence based on real-time feedback from the terminal, the system implements a closed-loop control mechanism over the recommendation process. This mechanism improves the technical performance of the computer system by adapting the content of the prompt sentence to the actual behavior of the user, thereby reducing the number of irrelevant recommendations generated and decreasing the volume of data transmitted and processed in subsequent cycles. When the generative AI model receives more focused and up-to-date prompts, the generated result is more compact and relevant, which reduces post-processing cost on the server and improves end-to-end latency perceived by the user.

In contrast to simple automation of human judgment, the server executes specific algorithms and data transformations that are not feasible to perform manually in real time. The server uses high-dimensional vector representations, neural attention mechanisms, and numeric optimization procedures to infer latent user preferences from sparse and noisy behavior logs. These computations operate on numerical tensors and tabular data, and their efficiency and accuracy depend on the architecture of the neural network and on the arrangement of data in memory. The system thus improves computer technology itself by optimizing data structures and processing flows for the particular task of constructing prompt sentences and mapping generated text back to structured product information, rather than merely converting human decisions into automated rules.

In some embodiments, the server may deploy different generative AI models depending on resource constraints or application requirements. For example, the server may use a smaller transformer model for users with limited behavior history, or a larger model for high-value users with extensive histories. The server may also adjust the temperature parameter or top-k sampling strategy in the generative AI model to control diversity of recommendations. By programmatically adapting these model parameters based on user behavior statistics and system load conditions, the server balances recommendation quality against computation cost, thereby further enhancing processing efficiency and scalability.

In another embodiment, the server may store precomputed embeddings of product titles and descriptions in the product information storage device. The server loads these embeddings into memory in a compact matrix format and performs similarity calculation processing using matrix-vector multiplication operations. Because these operations are highly optimized at the hardware level (for example, using vectorized instruction sets or specialized accelerators), the server can process large product catalogs and large numbers of candidate object names with low latency. This design reduces repeated text tokenization and encoding operations and thus reduces power consumption and processing load on the server.

In yet another embodiment, the terminal may perform part of the data pre-processing. The terminal may locally collect fine-grained interaction events and aggregate them into summary statistics, such as the number of views per category or per price range, before sending them to the server. This local aggregation reduces the number of network messages and the amount of raw event data transmitted over the network, which in turn reduces network traffic and processing overhead on the server. The server, upon receiving such aggregated information, incorporates it into the computation of preference information and the construction of the prompt sentence.

These embodiments demonstrate that the system is not limited to abstract data manipulation but instead provides concrete improvements in computer operation. The server modifies the way behavior logs are stored, represented, and processed; the server controls the configuration and invocation of a specific generative AI model architecture; the server optimizes similarity calculations and data transmission; and the terminal cooperates by structuring user interactions and presenting recommendation product information in real time. Through these technical measures, the system achieves faster recommendation generation, higher relevance accuracy, reduced error rates in product mapping, improved memory usage, and reduced network load, thereby improving the functioning of the computer system as a whole.

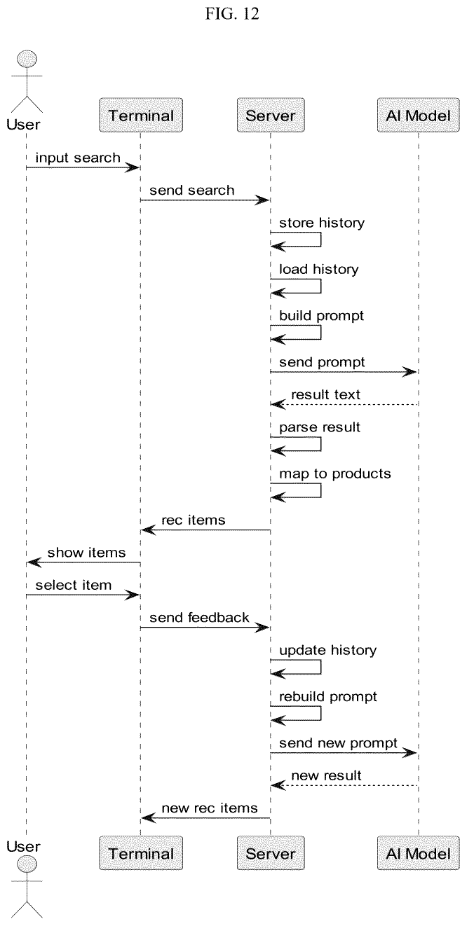

The following describes the processing flow using FIG. 12.

### Step 1:

The user operates the terminal to input a search request.

The user views a search screen on the terminal and enters one or more search keywords, such as “running shoes,” into a text input field. The user taps a search button on the touch screen.

The terminal receives, as input, the raw text keyword(s) typed by the user and a current session identifier stored in the terminal memory. The terminal formats these into a data structure including fields such as user identifier, search keyword text, timestamp, and device type.

The terminal outputs a request message containing this structured data and transmits the message to the server over a network using a communication protocol, for example via an HTTPS POST request.

### Step 2:

The server receives and stores behavior history information.

The server receives, as input, the request message from the terminal that includes the user identifier, search keyword text, and timestamp. The server uses a web framework to parse the message and extract these fields into in-memory variables.

The server performs data validation, such as checking that the user identifier exists in a user table and normalizing the search keyword text (for example, converting to lowercase and trimming whitespace). The server then executes a database write operation that inserts a new record into a search history table in a relational database. The record contains the user identifier, normalized keyword, timestamp, and additional metadata.

The server outputs an updated state in which the search history table in the storage device now includes the new search record, thereby extending the behavior history information associated with that user.

### Step 3:

The server retrieves accumulated behavior history information.

The server receives, as input, a recommendation trigger, which may be the same request message that contained the new search keyword or a separate request from the terminal asking for recommendations. The server extracts the user identifier from the trigger.

The server uses the user identifier to construct database queries that select records from the search history table and purchase history table. The server applies filters, such as limiting records to a recent time window or a maximum number of entries. The server executes these queries, and the database returns result sets.

The server outputs the result sets as lists or cursors and then converts them into tabular data structures (for example, DataFrames) in memory, representing search history information and purchase history information for the user.

### Step 4:

The server transforms history data into numerical and categorical features.

The server receives, as input, the tabular data structures representing the user's search history and purchase history. Each record includes at least a timestamp, a textual field (keyword or product name), and one or more category codes.

The server performs data processing using a numerical computation library. The server calculates occurrence counts for each keyword and each category by grouping rows and counting entries. The server computes recency scores by applying a time-decay function to timestamps, such as an exponential decay, and then aggregates these scores per keyword and per category. The server optionally normalizes these scores across all keywords and categories for the user.

The server outputs structured feature sets that include, for each keyword and each category, a frequency value, a recency value, and a combined preference score derived from these values. These feature sets are used as intermediate data for constructing a prompt sentence.

### Step 5:

The server selects representative behavior elements for the prompt sentence.

The server receives, as input, the structured feature sets for keywords and categories. Each entry includes a keyword or category identifier and its associated preference score.

The server performs a selection operation by sorting the entries in descending order of preference score and then choosing the top K keywords and top L categories that meet predetermined thresholds for score and minimum occurrence. The server may also enforce diversity constraints, such as avoiding multiple nearly identical keywords.

The server outputs two ordered lists: a list of selected keywords and a list of selected categories that represent the user's most relevant recent interests. These lists are transformed into text segments for the prompt sentence.

### Step 6:

The server constructs a prompt sentence in natural language.

The server receives, as input, the ordered lists of selected keywords and categories, as well as original search and purchase history text for context.

The server concatenates the selected keywords into a comma-separated string and does the same for selected purchased items or categories. The server inserts these strings into placeholder positions of a predefined template sentence. For example, the server forms:
“User search history: running shoes, trail running, waterproof sneakers
User purchase history: sportswear, running socks
Please generate recommended products that are suitable for a user interested in running and fitness accessories.”

The server ensures that the resulting prompt sentence length does not exceed a predetermined token limit by truncating or summarizing long lists.

The server outputs the generated prompt sentence as a natural-language string ready to be sent as input to the generative AI model.

### Step 7:

The server transmits the prompt sentence to the generative AI model and obtains a generated result.

The server receives, as input, the prompt sentence and a set of generation parameters, such as maximum output length, temperature, and sampling strategy.

The server formats these into an API request, including the prompt sentence and parameters, and sends the request to an external information processing apparatus that hosts the generative AI model, using a network protocol such as HTTPS. The external apparatus executes a transformer-based neural network that tokenizes the prompt sentence, computes token embeddings, applies multiple self-attention and feed-forward layers, and then generates output tokens one by one according to a probability distribution over the vocabulary.

The server receives, as output, a generated result in natural-language form, for example a text sequence listing recommended items: “Recommended products: running socks, fitness tracker, lightweight running shorts, hydration belt, compression calf sleeves.” The server stores this generated result in memory for further processing.

### Step 8:

The server parses the generated result into candidate object names.

The server receives, as input, the natural-language generated result from the generative AI model.

The server performs text parsing by removing any leading labels (for example, “Recommended products:”) and splitting the remaining text by delimiters such as commas, semicolons, or line breaks. The server trims whitespace and normalizes characters (for example, converting to lowercase) for each substring. The server may also apply additional linguistic processing, such as stemming, to reduce inflected forms to base forms.

The server outputs a list of candidate object names, each represented as a cleaned text string (for example, “running socks”, “fitness tracker”, “lightweight running shorts”, “hydration belt”, “compression calf sleeves”).

### Step 9:

The server maps candidate object names to catalog products.

The server receives, as input, the list of candidate object names and access to the product information storage device that holds product titles, descriptions, categories, and precomputed text embeddings.

The server computes or retrieves vector representations for each candidate object name using a text embedding model and aligns the dimensionality with precomputed product vectors.

The server then performs similarity calculation processing, such as computing cosine similarity scores, between each candidate vector and each product vector within a filtered subset (for example, restricted by category or price range). The server selects, for each candidate object name, one or more products with similarity scores above a threshold or within top-N ranking.

The server outputs a mapping from candidate object names to specific product identification information, along with similarity scores, thereby associating each generated text recommendation with one or more concrete catalog items.

### Step 10:

The server filters mapped products using inventory and supply conditions and builds recommendation product information.

The server receives, as input, the mapping between candidate object names and product identification information, together with inventory information and supply condition information stored in the product information storage device.

The server checks stock levels and region availability flags for each mapped product. The server discards products that have zero stock or are marked as unavailable for the user's region. The server can also enforce business-independent technical constraints, such as limiting the number of products per recommendation set to control payload size. The server then assembles structured records for each remaining product, including fields such as product identification information, price information, image reference information, and description information.

The server outputs recommendation product information as a structured list or array of product records, which is optimized for fast serialization and transmission to the terminal.

### Step 11:

The server sends recommendation product information and display control information to the terminal.

The server receives, as input, the structured recommendation product information and additional display control parameters, such as ordering preferences and layout type (for example, list view or grid view).

The server serializes the recommendation product information and display control parameters into a response message. The server transmits the response to the terminal via the communication interface using a network protocol. The server may compress the payload to reduce network bandwidth usage.

The server outputs, over the network, a response that enables the terminal to reconstruct the recommended product list on its display unit with the intended order and visual arrangement.

### Step 12:

The terminal receives and renders recommendation product information.

The terminal receives, as input, the response message from the server containing the recommendation product information and display control information. The terminal parses the structured data and extracts product records and layout instructions.

The terminal downloads product images identified by the image reference information using its communication interface. The terminal arranges visual components (such as image views, text labels, and buttons) on the display unit according to the display control information and populates them with product names, prices, and descriptions. The terminal maintains a local mapping between displayed items and product identification information.

The terminal outputs a rendered recommendation view on the display unit, presenting the recommended products to the user in real time.

### Step 13:

The user interacts with displayed recommendations and generates new behavior events.

The user views the recommended products on the terminal's display unit and scrolls through the list or grid. The user may tap a particular product card to view details or to add the product to a cart.

The terminal receives, as input, low-level interaction signals from the touch panel and scroll sensors, and translates them into higher-level events, such as “item viewed,” “item tapped,” or “item added to cart,” each associated with a product identification information and a timestamp.

The terminal outputs behavior events as structured records and sends these records back to the server as part of the behavior history information, thereby extending the data available for future recommendation cycles.

### Step 14:

The server updates behavior history and preference information based on feedback.

The server receives, as input, the new behavior events from the terminal, including viewing information and selection operation information.

The server writes these events into appropriate tables in the storage device, such as a recommendation interaction table. The server then recalculates preference scores for affected keywords and categories by incorporating the new events into the numerical computations used in Step 4. For example, the server increases weights for items that were selected and decreases weights for items that were ignored despite being shown. The server may apply different weight factors to different event types (for example, a purchase event contributes more to preference than a simple view).

The server outputs updated feature sets and revised preference information for the user, which will be used as input when constructing the next prompt sentence.

### Step 15:

The server generates refined prompt sentences and continues the recommendation cycle.

The server receives, as input, the updated feature sets and preference information derived after incorporating the new feedback events.

The server repeats the selection and template-insertion procedures of Steps 5 and 6, but now uses the updated scores that reflect the user's latest interactions. The server may generate a new prompt sentence such as:
“User search history: running shoes, trail running
User purchase history: sportswear, running socks
Recent interactions: viewed trail running shoes, selected hydration belt
Please generate recommended products focusing on trail running equipment and related accessories.”

The server outputs the refined prompt sentence and again transmits it to the generative AI model as in Step 7, thus maintaining a continuous loop that incrementally adapts recommendations based on incoming behavior data.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computerized recommendation systems generally rely on fixed feature engineering and static ranking logic executed by a processor on user history data. In such systems, the processor typically extracts limited attributes from search logs and purchase logs, applies predetermined similarity rules or collaborative filtering algorithms, and directly outputs item identifiers as recommendation results. This architecture causes several technical problems in terms of computing resource utilization, data handling, and interface control.

First, the processor in conventional systems cannot flexibly express complex behavioral patterns contained in large-scale behavioral history information. Because the processor is constrained to a fixed feature space and rule set, the system must either ignore a substantial portion of available history data or incur significant computational overhead to recompute features whenever the rule set is updated. As a result, the system suffers from inefficiencies in memory usage and processing throughput, especially when handling high-volume, high-frequency behavioral logs.

Second, conventional systems do not integrate a generative AI model into the core data processing pipeline in a way that structurally improves how the processor manages and transforms behavioral history information. In many cases, the processor either does not use a generative AI model at all, or uses such a model only as an auxiliary component without a systematic mechanism for constructing prompt sentences from aggregated history information and for reconciling the model output with internal data structures. This leads to inconsistent data formats between model outputs and stored product records, increases parsing and error-handling complexity in the processor, and limits the reliability and determinism of the overall recommendation process.

Third, traditional architectures do not treat the interaction between the recommendation engine and the user interface as an integrated, feedback-driven computation loop. The processor typically sends a static ranking of items to a terminal device, without coupling the subsequent transaction events and feedback from the interface back into the behavioral history information in a structured and timely manner. This causes the behavioral history store to become stale relative to actual user interactions, which in turn degrades the performance of any subsequent computation for recommendations and reduces the ability of the system to adapt to changes in user behavior in real time.

Furthermore, many systems lack a mechanism for the processor to use explanation information generated by a generative AI model to compute an interest index and to drive a deterministic, machine-controlled re-ranking process. In the absence of such a mechanism, explanations remain unstructured text that does not directly contribute to improved sorting, caching, or UI control decisions made by the processor. As a result, the processor cannot effectively exploit the semantic richness of generative outputs to optimize layout, prioritization, and loading strategies for the terminal device.

Accordingly, there is a need for a system architecture in which a processor systematically (i) acquires and aggregates behavioral history information into a form suited for generative processing, (ii) constructs and transmits structured prompt sentences and associated context to a generative AI model, (iii) converts generative outputs into internally consistent recommendation target information with additional metadata, (iv) coordinates with a terminal-side interface to control visual presentation based on machine-computed indices, and (v) updates the behavioral history store with transaction records in a tight feedback loop. Such an architecture is required to improve the technical functioning of the computer system itself, including the efficiency and accuracy of data processing, the robustness of model integration, and the responsiveness of the recommendation and display pipeline.

The specific processing by the specific processing unit 290 of the data processing device 12 in Example 2 is realized by the following means.

The present invention provides a server comprising a processor configured to acquire behavioral history information from a storage area based on user identification information, convert the acquired behavioral history information into aggregated history information including time information, classification information, and quantity information, construct in a natural language a prompt sentence that instructs a generative AI model to select highly relevant candidate items based on the aggregated history information, generate inquiry information including the prompt sentence and the aggregated history information, and transmit the inquiry information to the generative AI model, receive from the generative AI model a plurality of recommendation candidate pieces of information generated based on the prompt sentence, collate the recommendation candidate pieces of information with stored information so as to associate the recommendation candidate pieces of information with actual candidate items, format the associated candidate items as recommendation target information by adding inventory information, price information, and description information, transmit display information including the recommendation target information to a terminal device and cooperate with an interface that enables visual presentation of the recommendation target information on the terminal device, process transaction request information received from the terminal device based on the recommendation target information, generate a transaction record corresponding to the transaction request information, and append the transaction record to the behavioral history information in the storage area, and further configured to, in certain embodiments, acquire as the behavioral history information at least search history information and purchase history information, generate the aggregated history information including both the search history information and the purchase history information, construct the prompt sentence based on the aggregated history information, and rank the recommendation candidate pieces of information according to an interest index computed based on reason information output by the generative AI model and the behavioral history information, organize the recommendation target information according to the ranking, and generate display control information for visually presenting the recommendation target information via the interface. This enables an integrated computer-implemented recommendation pipeline in which behavioral history information is structurally aggregated for generative processing, prompt sentences are programmatically constructed and utilized to drive a generative AI model, model outputs are converted into machine-usable recommendation target information with consistent internal identifiers and metadata, user interface presentation is controlled based on machine-computed interest indices, and transaction events are fed back into the behavioral history store, thereby improving the efficiency, adaptability, and reliability of the recommendation processing performed by the server.

The term “processor” refers to a hardware execution unit, or a combination of hardware execution units, that performs arithmetic and logical operations on data according to programmed instructions, and that is capable of executing the functions described herein, including data acquisition, data transformation, communication, and control of external components.

The term “user identification information” refers to data that uniquely or quasi-uniquely identifies a user within a system, such as an identifier, account information, session information, or any token used by the server to associate behavioral history information and transaction information with a particular user.

The term “behavioral history information” refers to data representing past actions of a user with respect to digital content or items, including, but not limited to, search operations, browsing events, item selections, cart operations, and transaction events, which are stored in a storage area and used as input for recommendation processing.

The term “storage area” refers to a logical or physical data storage resource, such as a memory device, a storage device, a database, or a distributed storage system, in which behavioral history information, product information, transaction information, and related data are stored and from which such data can be read and updated by the processor.

The term “aggregated history information” refers to behavioral history information that has been processed by the processor into a summarized or structured form, including at least time information, classification information, and quantity information, and that is used as a compact representation of user behavior for subsequent analysis and recommendation generation.

The term “time information” refers to data representing temporal aspects of behavioral history information, such as timestamps, time intervals, recency indicators, or any derived temporal metrics that describe when user actions occurred.

The term “classification information” refers to data indicating one or more categories, types, or attributes associated with items or actions in the behavioral history information, such as product categories, content types, usage contexts, or any other classification labels used to group or characterize items.

The term “quantity information” refers to data indicating numerical aspects of behavioral history information, such as counts of actions, purchase quantities, frequency values, or aggregated metrics representing the magnitude of user interactions with items or categories.

The term “prompt sentence” refers to a text sequence, expressed in a natural language, that is constructed by the processor to instruct a generative AI model to perform a specific task, such as selecting highly relevant candidate items, and that encodes at least a part of the aggregated history information or related contextual information.

The term “generative AI model” refers to a computational model, typically implemented as a machine learning model such as a neural network, that generates output data, including text or structured information, in response to input data such as a prompt sentence, and that is capable of inferring relationships or recommendations based on such input.

The term “inquiry information” refers to data transmitted from the processor to the generative AI model, including at least one prompt sentence and associated context such as aggregated history information, and formatted in a way that allows the generative AI model to generate recommendation candidate pieces of information.

The term “recommendation candidate pieces of information” refers to output data generated by the generative AI model in response to inquiry information, representing suggested items, item attributes, or item descriptions that are predicted to be relevant to a user, prior to being mapped to actual items stored in the system.

The term “stored information” refers to data maintained in the storage area or another storage resource managed by the system, including product records, catalog information, inventory records, transaction records, and other reference data used to validate, map, or enrich recommendation candidate pieces of information.

The term “candidate items” refers to items, such as products, services, or content entities, that exist as records in stored information and that can be matched or associated with recommendation candidate pieces of information output by the generative AI model.

The term “recommendation target information” refers to data representing candidate items that have been selected for recommendation to a user, including associated metadata such as inventory information, price information, description information, and any identifiers necessary for display and transaction processing.

The term “inventory information” refers to data representing availability-related attributes of an item, such as stock quantity, stock status, replenishment status, or other indicators that determine whether the item can be offered or fulfilled in a transaction.

The term “price information” refers to data indicating a monetary value or range associated with an item, such as base prices, discounted prices, tax amounts, or other pricing parameters used for display and transaction calculation.

The term “description information” refers to data describing an item in a human-readable form, such as titles, textual descriptions, features, specifications, or other narrative or structured descriptions that can be presented to a user in an interface.

The term “display information” refers to data transmitted from the processor to a terminal device that includes recommendation target information and optionally layout or presentation parameters, and that is used by the terminal device to visually present recommended items to a user.

The term “terminal device” refers to an electronic device operated by or accessible to a user, such as a mobile device, a computing device, a display apparatus, or any client system capable of receiving display information, rendering an interface, and transmitting user input and transaction request information to the server.

The term “interface” refers to a software component, user interface module, or interaction layer on the terminal device that cooperates with the processor to visually present recommendation target information, receive user operations, and communicate such operations back to the server.

The term “transaction request information” refers to data transmitted from the terminal device to the processor indicating a user's intention to execute a transaction with respect to one or more recommendation target items, including at least identifiers of selected items and associated transaction parameters such as quantities or options.

The term “transaction record” refers to data generated by the processor in response to transaction request information, representing a confirmed or processed transaction, and including details such as item identifiers, quantities, prices, timestamps, and user identifiers.

The term “search history information” refers to a subset of behavioral history information representing past search operations performed by a user, including search queries, search filters, search timestamps, and related parameters that indicate how the user has searched for items or content.

The term “purchase history information” refers to a subset of behavioral history information representing past purchases or completed transactions performed by a user, including purchased item identifiers, quantities, prices, and transaction times.

The term “reason information” refers to explanatory data output by the generative AI model together with recommendation candidate pieces of information, indicating inferred reasons, rationales, or justification for why particular items are recommended to the user.

The term “interest index” refers to a numerical or ordinal measure computed by the processor based on reason information and behavioral history information, used to evaluate and rank the relevance or priority of recommendation candidate pieces of information or recommendation target information for presentation.

The term “display control information” refers to data generated by the processor that specifies how recommendation target information is to be visually presented via the interface, including, for example, ordering, grouping, emphasis, pagination, or other layout-related parameters controlled by the processor.

In one embodiment, a server includes a processor, a memory, a storage subsystem, and a network interface. The server is connected via a communication network to one or more terminal devices operated by users. Each terminal is, for example, a mobile communication device, a tablet device, or a general-purpose computing device including a display, an input interface, a local memory, and a communication module. A user operates the terminal to view recommended items and to execute transactions.

The server executes a recommendation program stored in the memory. The server runs an operating system, for example, a general-purpose operating system executing on a processor architecture such as x86_64 or ARM, and executes application software formed by modules including a history acquisition module, an aggregation module, a prompt generation module, a generative AI interaction module, a recommendation mapping module, a display information generation module, and a transaction processing module. The server stores behavioral history information, product catalog information, and transaction records in a storage subsystem implemented as a relational database system and, in some embodiments, a cache system. The storage subsystem can be implemented by a relational database management system such as a general-purpose SQL engine executing on non-volatile storage, and the cache system can be implemented by an in-memory key-value store executing on volatile memory.

The server stores, for each user, behavioral history information in a structured data format. The server stores, as behavioral history information, search history information, browsing history information, and purchase history information in multiple related tables. For example, the server stores search queries and timestamps in a search table, stores page view events with item identifiers in a page view table, and stores completed orders in an order table and an order item table. Each record includes at least a user identification information field, a time information field, a classification information field indicating a category of an item or action, and a quantity information field indicating a number of items or an intensity of an action.

The server aggregates behavioral history information into aggregated history information. The server uses a data processing module that executes on the processor and uses in-memory data structures such as arrays, hash maps, and compressed sparse representations. The server, for each user, groups records by classification information, computes counts of actions per classification, computes recency scores by transforming timestamps into decayed weights, and computes normalized frequency values. The server, for example, converts a raw sequence of page views and purchases into a vector representation in which each dimension represents a category and each element represents a weighted count. This aggregation reduces data size, improves cache locality, and enables efficient use of the generative AI model input context.

The server converts aggregated history information into a natural-language description. The server retrieves product names, generic category labels, and short descriptions from a product catalog table and combines them with time information and quantity information. The server generates human-readable segments such as “running shoes purchased three times in the last 90 days” or “fitness apparel viewed frequently during the last month.” The server concatenates these segments into a history summary string that is used as part of a prompt sentence for the generative AI model.

The server constructs a prompt sentence in a natural language. The server uses a prompt generation module that inserts the aggregated history information and additional control instructions into a template. In one example, the server generates a prompt sentence such as:
“Based on the following user history: running shoes purchased three times in the last 90 days, fitness T-shirts viewed frequently during the last month, and sports shorts purchased once in the last 60 days, please recommend three sports-related products that this user is likely to purchase next. Use concise product names and one-sentence reasons for each recommendation.”

In another example, the server generates a prompt sentence such as:
“Using the user's past purchase and browsing history described below, select three items that are most relevant to the user's interests. For each item, output a product name, a category, and a short explanation of why it is recommended: [history summary].”

The server does not merely describe the user's history but also encodes constraints on output format, number of recommendations, and types of items. The server, by constructing such prompt sentences, converts compressed behavioral history vectors and classification metadata into a domain-specific, machine-readable instruction that drives the generative AI model to perform a specific ranking and selection task.

The server interacts with a generative AI model hosted either on the same physical infrastructure or on a remote computing infrastructure accessed through a network interface. The generative AI model is implemented, in one embodiment, as a multi-layer neural network of the transformer type. The generative AI model includes an embedding layer, a plurality of self-attention layers, feedforward layers, and an output projection layer. The generative AI model has been previously trained on a large set of text sequences including item descriptions and user interaction narratives. During training, the generative AI model minimizes a loss function such as a cross-entropy loss between predicted and actual tokens using an optimization algorithm such as stochastic gradient descent with adaptive learning rate. The generative AI model updates internal weight parameters by backpropagation of gradients computed from the loss function. In some embodiments, the generative AI model is fine-tuned on domain-specific data containing item descriptions and labeled recommendation examples, and may use regularization techniques such as dropout, weight decay, and early stopping to reduce overfitting.

The server converts aggregated history information into token sequences using a tokenizer associated with the generative AI model. The server maps tokens to numeric indices and constructs an input sequence vector passed to the generative AI model through an inference interface. The generative AI model receives the tokenized prompt sentence and generates output tokens that are decoded into a natural-language response. The generative AI model outputs, for each recommendation candidate, a textual item description, a category, and an explanation. The server, using the generative AI interaction module, enforces a deterministic output structure by constraining the prompt sentence and by post-processing delimiters in the model output. This structured interaction reduces parsing errors and ensures that the generated content can be mapped to internal identifiers efficiently.

The server converts the model output into machine-usable recommendation candidate pieces of information. The server executes matching algorithms that use text similarity measures, such as token-based similarity and embedding-based similarity, to match the generated item descriptions and categories to stored product records. In one embodiment, the server projects both generated text and catalog item descriptions into a shared vector space using a separate embedding model, computes similarity scores by cosine similarity, and selects items with scores above a threshold. The server further consults an index structure, such as an inverted index or a full-text search index, to narrow candidates before computing detailed similarity. These algorithms reduce the number of database lookups and improve mapping precision, which leads to efficient real-time recommendation.

The server augments the matched candidate items with inventory information, price information, and description information. The server queries the storage subsystem to retrieve stock status and current prices, and attaches these fields to each candidate. The server filters out items that are out of stock or disabled for sale. The server forms recommendation target information objects that include an internal item identifier, display name, category label, image reference, price, stock status, and explanation text from the generative AI model. The server stores these objects temporarily in memory structures optimized for sequential access and network serialization.

The server computes an interest index for each recommendation candidate. The server analyzes the explanation text output by the generative AI model and behavioral history information using a deterministic algorithm. For example, the server extracts keywords related to categories or usage contexts from the explanation text using a rule-based parser, and assigns weights based on how frequently corresponding categories appear in aggregated history information. The server may compute a score as a weighted sum of normalized recency, frequency, and explanation-derived relevance. This interest index is not merely a repetition of human scoring but is computed in a way that integrates machine-generated semantic information with machine-computable behavioral statistics. The server then ranks the recommendation target information according to this interest index.

The server generates display information for the terminal. The server organizes recommendation target information into an ordered list, adds layout hints such as grouping by category or splitting into primary and secondary sections, and serializes this structure into a data format for transmission. The server includes, for each item, fields indicating position, emphasis level, and display priority. The server transmits this display information over a communication network using a defined application protocol. The server thereby controls, from the server side, the order and layout of recommended items on the terminal, improving cache locality on the terminal and reducing redundant network requests.

The terminal receives display information from the server and renders a user interface. The terminal executes a client application that includes a recommendation display module and a transaction module. The terminal constructs visual components such as item cards, lists, and carousels using the fields received from the server. The terminal displays product names, prices, and explanation text on a display device. The terminal, by following server-specified positions and priorities, can prefetch images and preload content for items with high interest index while deferring or omitting low-priority content. This selective loading reduces network consumption and improves responsiveness.

The user views recommended items on the terminal display and selects one or more items. The user may tap an item card to open a detailed view or activate a purchase control. The terminal converts user operations into transaction request information, including selected item identifiers, quantities, and user-specific parameters such as shipping profile identifiers. The terminal transmits this transaction request information to the server over the communication network.

The server receives transaction request information and executes transaction processing. The server validates the user identification information and checks inventory for selected items. The server calculates a transaction total using price information and applicable calculation rules. The server records a transaction record in the storage subsystem, including item identifiers, quantities, timestamps, and user identification information. The server appends this transaction record to the behavioral history information for the user. The server, by updating behavioral history in near real time, maintains a consistent state between recommendation logic and actual user behavior, which enables subsequent prompt sentences and recommendations to reflect recent transactions.

The server, by implementing the described data structures and processing flow, improves computer technology in several ways. First, the aggregation of raw behavioral history into compressed vectors and structured summaries reduces the amount of data that must be transmitted to and from the generative AI model and stored in memory at inference time, which increases processing speed and reduces memory footprint. Second, the programmatic construction of prompt sentences that fuse aggregated history information with control instructions allows the generative AI model to operate under well-defined constraints, which reduces output variability and post-processing complexity. Third, the matching algorithm that uses both textual similarity and precomputed vector embeddings provides a non-conventional, machine-specific mapping from generative outputs to database records, improving mapping accuracy and reducing the number of failed or ambiguous matches compared with manual or naive keyword matching.

In addition, the server uses explanation text from the generative AI model not only as a human-readable message but also as a machine-readable signal for computing an interest index. This dual use of explanation text is implemented by algorithms that extract structured features from natural-language explanations and combine them with temporal and frequency-based metrics. This design enables a ranking procedure that is specific to machine computation and not equivalent to a simple automation of human judgment. The resulting ranking improves precision of recommendations and user interface performance, for example, by presenting the most relevant and most likely purchasable items earlier and by minimizing unnecessary screen updates on the terminal.

The generative AI model itself is implemented with a specific neural network architecture and training regimen. The server or a separate training infrastructure stores training data consisting of pairs of history summaries and human-curated recommendation lists. During training, the generative AI model receives tokenized input sequences that include history descriptions and explicit instruction phrases such as “recommend three items likely to be purchased next.” The training process computes a prediction for each next token in the target recommendation sequence and minimizes a loss function representing the difference between the prediction and the actual target sequence. The training environment uses mini-batch processing, gradient clipping, and learning rate scheduling to stabilize convergence. This training process results in internal weight parameters that are specialized to the domain and enable the model to infer user preferences from aggregated history in a way that cannot be trivially replicated by rule-based algorithms.

The server, in some embodiments, uses alternate configurations of the generative AI model and aggregation logic. In one variation, the server uses a smaller-sized generative AI model that operates on reduced context windows, and adjusts the aggregation process to produce concise history summaries with higher information density. In another variation, the server uses a larger generative AI model with extended context capacity, and includes multiple segments of behavioral history such as short-term and long-term patterns in the same prompt sentence. In yet another variation, the server uses ensemble techniques in which outputs from a generative AI model and outputs from a conventional recommendation model are combined, and the processor applies deterministic rules to resolve conflicts and produce final recommendation target information.

The terminal, in some embodiments, performs additional local processing to further reduce communication load. For example, the terminal may locally cache recommendation target information received from the server and re-use it when network connectivity is limited. The terminal may also locally compute a simplified interest index adjustment based on short-term interactions, such as immediate clicks or skips, and combine this with the server-provided interest index to refine presentation. This distributed processing leads to reduced server load and improved latency for the user.

The user experiences improved responsiveness and relevance in the recommendation interface because the server and the terminal cooperate to perform efficient, technically-structured computations. The described architecture yields concrete technical effects: reduction in network traffic by transmitting aggregated and ranked recommendations instead of full catalog data, reduction in server processing time due to pre-aggregation and constrained prompt design, improved accuracy of mapping between generative outputs and internal records through specialized matching algorithms, and improved data management because behavioral history, recommendations, and transactions are stored and updated in a consistent, machine-readable format.

In summary, the server, the terminal, and the user interact through a system in which behavioral history information is acquired, aggregated, converted into prompt sentences, processed by a specifically structured generative AI model, mapped to internal data records, ranked by machine-computed indices, and presented through an interface whose behavior is controlled by display control information. This configuration, in multiple embodiments and variations, provides an implementation that goes beyond abstract idea processing and results in an improvement of computer-based recommendation technology in terms of processing efficiency, data handling, and display control.

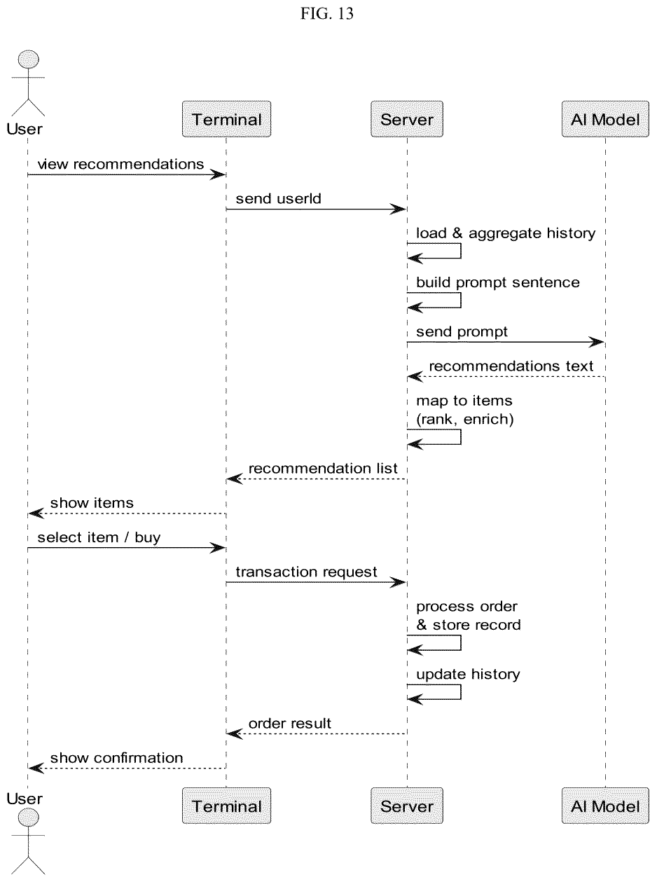

The following describes the processing flow using FIG. 13.

### Step 1:

The server receives user identification information from the terminal and acquires behavioral history information.

The server uses the user identification information as input and executes database queries against a storage subsystem. The server reads search history information, browsing history information, and purchase history information from multiple tables or collections. The server joins these records by the user identification information and outputs a unified behavioral history dataset that includes item identifiers, timestamps, action types, and quantities. The server thereby converts dispersed log records into a coherent input dataset for further processing.

### Step 2:

The server aggregates the behavioral history information into aggregated history information.

The server takes the unified behavioral history dataset as input and performs data aggregation operations. The server groups events by classification information such as item category, computes counts and frequencies as quantity information, and transforms timestamps into recency scores as time information. The server applies normalization functions (for example, dividing counts by total actions) and exponential decay functions to older events. The server outputs aggregated history information in a compact structure where each entry contains classification information, aggregated quantity information, and derived time information for the corresponding user.

### Step 3:

The server generates a natural-language summary of the aggregated history information.

The server uses the aggregated history information as input, along with product catalog records retrieved from storage. The server looks up human-readable names and category labels for each classification, then composes textual phrases such as “running shoes purchased three times in the last 90 days” or “fitness apparel viewed frequently during the last month.” The server concatenates these phrases into a single history summary string. The output of this step is a history summary text that describes the user's behavior in natural language.

### Step 4:

The server constructs a prompt sentence for a generative AI model.

The server takes the history summary text and configuration parameters (for example, the number of recommendations to generate and the desired output format) as input. The server inserts the history summary into a predefined template and appends explicit instructions. For example, the server generates a prompt sentence such as:
“Based on the following user history: running shoes purchased three times in the last 90 days, fitness T-shirts viewed frequently during the last month, and sports shorts purchased once in the last 60 days, please recommend three sports-related products that this user is likely to purchase next. Use concise product names and one-sentence reasons for each recommendation.”

The server outputs a complete prompt sentence string that will be consumed by the generative AI model.

### Step 5:

The server encodes the prompt sentence and sends inquiry information to the generative AI model.

The server takes the prompt sentence as input and passes it through a tokenizer associated with the generative AI model, converting text into token identifiers or embeddings. The server constructs inquiry information that includes the encoded prompt sentence and optional parameters such as maximum token length and temperature. The server sends this inquiry information through a network interface to the generative AI model endpoint. The output of this step is a network request containing the encoded prompt sentence and control parameters.

### Step 6:

The generative AI model generates recommendation candidate pieces of information.

The generative AI model receives the encoded prompt sentence as input. The generative AI model processes the input with a neural network architecture that includes an embedding layer, multiple self-attention layers, and feedforward layers, computing contextual representations for each token. The generative AI model iteratively predicts next tokens based on probability distributions, forming an output sequence that describes recommended items and reasons. The model output is a natural-language response, for example a list of product names, categories, and explanations. The generative AI model returns this response to the server as output.

### Step 7:

The server decodes and parses the response from the generative AI model.

The server takes the response text from the generative AI model as input and applies a decoder to convert token identifiers back into a character string when necessary. The server uses parsing logic, such as delimiter-based splitting and pattern matching, to segment the response into individual recommendation candidate pieces of information. For each candidate, the server extracts a generated product name string, a generated category string, and an explanation string. The server outputs a structured list of recommendation candidate pieces of information in an internal data format.

### Step 8:

The server maps recommendation candidate pieces of information to actual candidate items.

The server uses the structured list of recommendation candidate pieces of information as input and consults stored product catalog records. The server computes text similarity between generated product names and catalog item names, and between generated category labels and catalog categories. The server may compute embedding vectors for both generated texts and catalog texts and calculate similarity scores. Based on these scores, the server selects catalog items that best match each recommendation candidate. The server outputs a list of mapped candidate items with internal identifiers linked to the original recommendation candidates.

### Step 9:

The server enriches mapped candidate items to form recommendation target information.

The server takes the mapped candidate items as input and queries storage for additional fields such as current price, stock status, image references, and detailed descriptions. The server filters out items that are out of stock or disabled. The server creates recommendation target information objects that include item identifiers, display names, classification information, price information, inventory information, description information, and explanation text obtained from the generative AI model. The output of this step is a recommendation target information list suitable for presentation and transaction processing.

### Step 10:

The server computes an interest index and ranks the recommendation target information.

The server uses the recommendation target information list and the underlying behavioral history information as input. The server analyzes explanation text to extract keywords and category references, matches them against aggregated history statistics, and calculates a numerical interest index for each recommendation target. The server applies an algorithm that combines recency scores, frequency counts, and explanation-derived relevance weights, for example by computing a weighted sum or a non-linear scoring function. The server sorts the recommendation target information in descending order of interest index. The output of this step is a ranked recommendation target information list.

### Step 11:

The server generates display information for the terminal.

The server takes the ranked recommendation target information list as input and constructs display information including layout hints. The server assigns position indices (for example, top, middle, bottom), grouping labels (for example, “primary recommendations” and “secondary recommendations”), and emphasis flags (for example, highlight level). The server packages item fields and layout hints into a data structure suitable for network transmission. The output of this step is display information that prescribes both content and ordering of recommendations.

### Step 12:

The server transmits display information to the terminal.

The server uses the display information as input and serializes it into a transferable format. The server sends the serialized data through the network interface using a communication protocol. The server may compress the data and set headers to indicate content type and caching policies. The output of this step is a network response delivered to the terminal containing the complete display information.

### Step 13:

The terminal receives the display information and prepares a user interface.

The terminal takes the display information as input and deserializes it into internal data structures. The terminal instantiates visual components, such as list items or cards, corresponding to each recommendation target. The terminal reads position indices and emphasis flags to determine the rendering order and visual style. The terminal outputs a configured user interface state, ready to be drawn on the display.

### Step 14:

The terminal renders recommendation target information on the display.

The terminal uses the configured user interface state as input and invokes a rendering engine of the operating system. The terminal draws product images, names, prices, and explanations on the display according to the positions and styles specified by the server. The terminal may preload high-priority images and delay loading of low-priority content based on the interest index. The output of this step is a visible recommendation screen presented to the user.

### Step 15:

The user observes the recommendation screen and selects an item.

The user uses the recommendation screen as input, visually inspects the recommended items, and chooses an item of interest by performing a touch or click operation on the terminal. The user thereby generates a selection event that includes an identifier of the selected item and the type of action (for example, view details or purchase). The user's action triggers the next processing step; the output of this step is user interaction data captured by the terminal.

### Step 16:

The terminal converts the user interaction into transaction request information.

The terminal takes the user interaction data as input and compiles transaction parameters such as selected item identifier, desired quantity, and user profile references (for example, shipping address ID). If the user initiates a purchase, the terminal may also invoke a local payment interface to obtain payment tokens. The terminal packages these parameters into transaction request information. The output of this step is a structured transaction request ready to be sent to the server.

### Step 17:

The terminal transmits the transaction request information to the server.

The terminal uses the transaction request information as input and serializes it into a network request. The terminal sends the request over the communication network to the server. The terminal may encrypt the payload and attach authentication data such as a session token. The output of this step is a network message containing transaction request information delivered to the server.

### Step 18:

The server processes the transaction request and generates a transaction record.

The server takes the transaction request information as input and validates user identification information, item identifiers, and quantities. The server checks inventory by querying the storage subsystem and ensures that requested quantities are available. The server calculates a transaction total using price information and applicable calculation rules. The server creates a transaction record that includes item identifiers, quantities, prices, timestamps, and user identification information, and writes this record into the storage subsystem. The output of this step is a stored transaction record representing a completed or confirmed transaction.

### Step 19:

The server appends the transaction record to the behavioral history information.

The server uses the transaction record as input and constructs a new behavioral history entry that encodes the transaction as a purchase event. The server assigns time information from the transaction timestamp, classification information from the item categories, and quantity information from the purchased quantities. The server inserts this entry into the behavioral history tables associated with the user. The output of this step is an updated behavioral history dataset that reflects the latest transaction.

### Step 20:

The server updates cached aggregated history information for future recommendations.

The server takes the updated behavioral history dataset as input and incrementally updates the aggregated history information. The server recalculates counts, frequencies, and recency scores for affected categories based on the new transaction record. The server overwrites or refreshes aggregated vectors in an in-memory cache. The output of this step is an updated aggregated history information structure that will serve as improved input for the next prompt sentence and the next interaction with the generative AI model.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented recommendation systems typically rely on fixed heuristic algorithms or static machine learning models that consume pre-defined feature vectors derived from user history data. In such systems, a server generally computes similarity scores or collaborative-filtering metrics against a product database and outputs a ranked list of items. These approaches suffer from several technical limitations.

First, traditional recommendation engines are tightly coupled to specific data schemas and feature definitions, making it difficult for the server to flexibly incorporate heterogeneous signals such as detailed user behavior logs, dynamic context, and emotion-related information obtained from terminals. As a result, even when rich interaction logs and emotional cues are available, the system cannot effectively exploit these signals to generate high-quality recommendations in real time.

Second, in many existing architectures, the server uses rigid, parameter-tuned pipelines rather than a generative AI model driven by explicit prompt sentences. The server therefore cannot dynamically re-formulate the recommendation problem in natural-language terms as context changes. This limits the adaptability of the system to rapidly evolving user states, and increases computational overhead because separate specialized models or rule sets must be maintained for each scenario.

Third, conventional systems treat the user's emotion state, if considered at all, as a simple weighting factor in a scoring function, without any structured integration into the core inference process. As a consequence, the server cannot systematically combine emotion-related signals with behavior history and current request information to guide a generative AI model, and cannot update recommendation results promptly in response to real-time emotion changes detected at the terminal. This leads to sub-optimal use of network resources and computational resources, as the server either recomputes large recommendation sets from scratch or serves stale results that do not match the user's current state.

Fourth, existing server architectures often lack an explicit prompt-generation layer that transforms structured logs (search history, purchase history, interaction events) and emotion states into a unified natural-language context for a generative AI model. Without such an intermediate abstraction, integration with a generative AI model is ad-hoc and brittle: the server must rely on manually crafted, static prompts that do not fully reflect the current user context, and the quality and consistency of recommendations degrade.

Accordingly, there is a need for an improved computer-implemented recommendation system in which a processor of a server is configured to (i) acquire and preprocess user behavior history, (ii) estimate a user's emotion state from emotion-related information acquired from a terminal, (iii) synthesize these signals into a dynamically updated prompt sentence in natural-language form, (iv) invoke a generative AI model based on the prompt sentence, and (v) map the model's response to concrete information objects managed by an information resource management apparatus and present them in a structured recommendation list. Such a system should reduce the coupling between low-level data schemas and high-level recommendation logic, make more efficient use of computing and network resources by updating only the parts of the recommendation that depend on changing context, and improve the technical functioning of the server-terminal interaction pipeline by enabling real-time, context-aware recommendation generation.

The specific processing by the specific processing unit 290 of the data processing device 12 in Application Example 2 is realized by the following means.

The present invention provides a server comprising a processor configured to acquire behavior history information of a user from one or more storage devices, generate a prompt sentence in a natural-language form based on the acquired behavior history information and current request information of the user, the prompt sentence being for instructing a generative information processing model to select one or more highly relevant information objects, invoke the generative information processing model using the prompt sentence and obtain response information indicating the one or more highly relevant information objects from the generative information processing model, analyze attribute information of candidate objects included in the response information and acquire corresponding information object data from an information resource management apparatus based on the attribute information, generate a structured recommendation list including the acquired information object data and transmit the structured recommendation list to a user terminal, analyze emotion-related information acquired from the user terminal to estimate an emotion state of the user, and dynamically update the prompt sentence by combining the emotion state with the behavior history information and re-executing invocation processing of the generative information processing model so as to update the structured recommendation list in real time. This enables an improvement in the functioning of the computer-implemented recommendation system by allowing the server to flexibly integrate heterogeneous behavior and emotion signals into a unified prompt-driven interaction with the generative AI model, to reduce processing overhead through targeted, context-aware regeneration of recommendation results, and to provide the user terminal with real-time, emotion-adaptive recommendation lists that more efficiently utilize computational and communication resources.

The term “behavior history information” refers to machine-readable data representing past actions of a user in relation to one or more information objects, including at least one of access logs, search logs, browsing logs, and transaction logs recorded by a computing apparatus.

The term “current request information” refers to machine-readable data representing an operation or request that a user issues at a given time to a computing apparatus, including at least one of a search query, a navigation command, a selection input, and a purchase instruction.

The term “prompt sentence” refers to a sequence of symbols expressed in a natural-language form that is generated by a processor to instruct a generative information processing model to perform a specified processing operation, including selection or generation of one or more information objects.

The term “generative information processing model” refers to an artificial intelligence model that receives a prompt sentence as an input and generates response information by performing data-driven inference, the artificial intelligence model including at least one of a statistical model, a neural network model, and a large-scale language model.

The term “information object” refers to a logical unit of content or an item managed by an information resource management apparatus, including at least one of a product record, a content record, a service record, and a metadata record usable for recommendation.

The term “response information” refers to output data produced by a generative information processing model in response to a prompt sentence, the output data including at least one of textual descriptions, identifiers, attribute values, and ranking information corresponding to one or more information objects.

The term “attribute information” refers to data representing properties or characteristics of an information object, including at least one of a name, a category, a type, a brand, a tag, a price, and a descriptive feature.

The term “information resource management apparatus” refers to a computing apparatus that stores and manages information object data, including at least one of a database system, a content management system, and an electronic commerce management system.

The term “information object data” refers to structured or semi-structured data representing an information object and its attributes, including at least one of identifiers, descriptive fields, media references, and transactional parameters.

The term “structured recommendation list” refers to a machine-readable data structure that enumerates a plurality of information objects selected for recommendation and associates each information object with corresponding information object data in a format suitable for programmatic processing and presentation.

The term “user terminal” refers to an end-user computing device capable of communicating with a server, including at least one of a smartphone, a tablet device, a personal computer, and a network-connected display device.

The term “emotion-related information” refers to data acquired from a user terminal that can be used to estimate an emotion state of a user, including at least one of image data, audio data, textual data, and interaction patterns.

The term “emotion state” refers to a representation of a user's emotional condition at a given time, expressed as at least one of a categorical label, a continuous score, and a probability distribution over a plurality of emotion categories.

The term “preference information” refers to data representing a tendency of a user to favor certain types of information objects or attributes, the tendency being inferred from at least one of search history information, purchase history information, and interaction history information.

The term “context information” refers to combined data that includes at least behavior history information, current request information, preference information, and emotion state of a user, and that is used to generate a prompt sentence in a natural-language form.

The term “display data structure” refers to a data representation that arranges information objects and their attributes in a format suitable for rendering on an interactive graphical user interface of a user terminal.

In one embodiment, a server, a plurality of user terminals, and one or more information resource management apparatuses are interconnected via a communication network. The server includes at least one processor, a main memory, a non-volatile storage device, and a network interface. The processor executes a program stored in the non-volatile storage device to implement the functions described below. The non-volatile storage device stores executable modules such as a data acquisition module, a feature extraction module, a prompt generation module, a generative AI interface module, a response interpretation module, a recommendation list generation module, an emotion analysis interface module, and a presentation control module.

The server uses a general-purpose operating system, a server-side framework such as a web application framework, and a database management system. For example, the server uses a relational database system to store behavior history information and information object data, and the server uses a server-side framework to provide application programming interfaces (APIs) to the user terminals. The server executes data-processing code written in a general-purpose programming language such as a scripting language or a compiled language. The server also uses numerical computation libraries and machine learning libraries, including a tensor computation framework and a data-analysis library, to implement the feature extraction module and generative model integration.

The server represents behavior history information of a user as one or more structured records in the database. Each record includes at least a user identifier, an information object identifier, a timestamp, one or more categorical attributes (for example, object category codes and type codes), and one or more numerical attributes (for example, a price value or a duration value). The server additionally stores search history information as query text strings associated with timestamps and user identifiers. The server further stores interaction history information such as clicks on recommended objects, dwell times for displayed objects, and purchase completions.

The server reads behavior history information from the database and converts the information into a feature representation suitable for processing by an artificial neural network. The server uses a data-analysis library to perform operations such as grouping records by user identifier, sorting by timestamp, and computing aggregate statistics. For example, the server computes, for each user and for each category of information object, a purchase count, a recency value based on the time difference from the current time, and an average value of a numerical attribute. The server encodes categorical attributes into integer indices and then maps these indices to dense embedding vectors. The server normalizes numerical attributes using at least one of min-max normalization and z-score normalization to generate feature vectors.

The server stores, in the non-volatile storage device, a generative AI model that implements a multi-layer neural network architecture, or configuration information for accessing such a model provided on an external computing apparatus. In one embodiment, the server stores a generative language model that includes a plurality of self-attention layers and feed-forward layers configured in a transformer-type architecture. The model parameters include weight matrices and bias vectors for each layer, learned from training data. The model receives a prompt sentence tokenized into a sequence of discrete tokens, embeds the tokens into a high-dimensional vector space, applies multi-head self-attention operations to compute contextualized representations, and produces output token probabilities that are decoded into textual response information.

The server trains the generative AI model or fine-tunes the model on a training dataset that consists of pairs of input context descriptions and target recommendation outputs. The server uses supervised learning with a loss function such as cross-entropy loss between predicted token distributions and target token distributions. The server performs gradient-based optimization such as stochastic gradient descent or an adaptive optimization method. The server updates model parameters by backpropagating error signals through the transformer layers. The server may augment training data by randomly masking, shuffling, or paraphrasing parts of prompts, thereby improving robustness to variation in context expressions.

The server generates a prompt sentence in a natural-language form based on behavior history information and current request information of the user. The prompt generation module receives feature representations from the feature extraction module and reconstructs them into a human-readable description. For example, the server maps frequently purchased categories to descriptive phrases and inserts them into a template. The server also appends current search query terms and current session context. When emotion-related information is available, the server inserts an indication of a current emotion state into the prompt sentence.

The server may generate prompt sentences such as:
“Based on the user's past purchase history, please propose 3 products that the user is highly likely to buy next. The user often purchases sports goods and running shoes.”
“The user has frequently purchased sneakers and sportswear from multiple brands. The current search keyword is ‘sneakers’. The current emotion is joy. Please propose 5 sneaker products that match this user's preferences and joyful mood.”
“The user frequently searches for outdoor gear and camping equipment and has purchased hiking boots and tents. Please propose 5 new outdoor products that will be highly relevant to this user's interests.”
“The user is currently feeling sadness. The user's search history includes relaxation goods, aroma, and healing music. The user's purchase history includes a yoga mat and a relaxation CD. Please propose 5 products that provide relaxation or healing and are suitable for a user who is feeling sad.”

The server transmits the prompt sentence to the generative AI model. In an on-premise embodiment, the server passes the prompt sentence as a sequence of token identifiers to the transformer-type neural network stored in the server's memory. The processor performs tensor operations to propagate token embeddings through the self-attention layers, computes attention scores by multiplying query, key, and value matrices, and obtains an output sequence representing the generative AI model's response. The server then converts the output sequence back to characters and words to form the response information.

In another embodiment, the server accesses an external generative AI model provided on a remote computing apparatus. The server transmits the prompt sentence over the communication network using a request message that specifies a model identifier and generation parameters such as a maximum token length and a randomness parameter. The remote computing apparatus returns response information as a textual sequence. The server parses the response information to identify references to information objects by detecting names, categories, or attribute expressions.

The server interprets the response information by applying a response interpretation module. The server tokenizes the response text and performs named-entity recognition, part-of-speech tagging, or pattern matching to extract candidate object names, brand-like terms, category-like terms, and other attribute-like phrases. The server then submits lookup queries to the information resource management apparatus to find matching information object data. For example, the server searches for records whose name or attribute fields approximate the extracted phrases, using fuzzy matching or word-embedding similarity.

The server generates a structured recommendation list as a data structure such as a list of elements, where each element contains an information object identifier, selected attribute fields, and one or more presentation attributes such as display order and highlighting flags. The server may assign scores to candidates by combining signals from the generative AI model (for example, position in the output sequence) and from behavior history features (for example, similarity of category embeddings). The server stores the recommendation list temporarily in memory and transmits it to the user terminal via a communication interface as a serialized format such as a structured text or a structured binary encoding.

The user terminal includes a processor, a display unit, an input unit, an image capture device, an audio capture device, a memory, and a network interface. The user terminal executes a client-side application that renders an interactive user interface. The terminal receives the recommendation list from the server, parses the data structure, and generates display data structures such as arrays of product cards. The terminal draws visual components representing information objects on the display, including text labels, images, and control elements such as buttons and links. The terminal accepts user operations such as touches or clicks and transmits corresponding selection signals to the server.

The terminal also acquires emotion-related information. The terminal uses the image capture device to capture images or video frames of a user's face while the user is interacting with the interface. The terminal uses the audio capture device to capture voice signals. The terminal transmits at least one of the image data and audio data to the server, or to an emotion analysis apparatus accessible to the server, with time stamps correlated to interface events.

The server uses an emotion analysis interface module to communicate with an emotion analysis model or service. The emotion analysis model may be implemented as a convolutional neural network for facial expression recognition and/or a recurrent neural network or transformer-type model for voice emotion recognition. The server passes preprocessed image and audio features to the model. For facial images, the server may detect facial landmarks, crop and normalize face regions, and feed the normalized images into the neural network. For voice signals, the server may compute spectrograms or mel-frequency cepstral coefficients and feed them into the model. The model outputs emotion state data in the form of probability values over emotion categories such as joy, sadness, anger, and neutral. The server selects a dominant emotion category and may also store the probability distribution.

The server combines the estimated emotion state with behavior history information and current request information. The prompt generation module updates or regenerates the prompt sentence in response to changes in the emotion state. When the server detects that the emotion state has changed beyond a threshold (for example, probability of sadness exceeding a predetermined value), the server produces a modified prompt that explicitly includes the updated emotion state and a description of recent user interactions. The server re-invokes the generative AI model with the modified prompt and obtains updated recommendations. The server thus provides real-time adaptation of recommendation content based on user emotion.

The server's architecture improves the functioning of the computer system in several technical respects. Because the server uses a prompt sentence to encapsulate heterogeneous context information, including behavior features, current request, and emotion state, it decouples low-level schema designs from high-level recommendation logic. The server does not require separate specialized models for each combination of signals; instead, the generative AI model consumes unified prompts, reducing memory usage and maintenance complexity. The server avoids exhaustive recomputation of recommendations by selectively regenerating only the portions that depend on evolving context, which reduces processor load and network traffic.

The server also achieves improved recommendation accuracy and latency. The neural network model employed for feature extraction and prompt construction produces dense vector representations of user behavior that capture long-term dependencies across sequences of interactions. The transformer-type generative AI model can interpret rich prompt sentences that describe nuanced combinations of user interests and emotion states, and can generate contextually appropriate candidate objects without enumerating the entire catalog. As a result, the server reduces search space and computation compared to traditional collaborative filtering that must compute similarity across many users and items for each request.

The server further improves data management by storing feedback signals such as clicks on recommended objects and subsequent purchases. The server uses these feedback signals in a retraining loop to adjust embeddings and attention weights in the neural networks. The server may employ an online learning strategy where new data batches are periodically incorporated, with regularization to maintain stability. The server thereby refines its internal feature representation and reduces prediction error over time.

The server performs processing that is not a mere automation of human decision making. The server uses high-dimensional feature vectors, attention mechanisms, and emotion-aware context composition, which are not practical to apply manually. The generative AI model uses non-linear transformations across many layers, learns latent structures in the interaction data, and computes probabilistic rankings that optimize a loss function over large datasets.

The server further implements non-conventional, prompt-driven control flow: instead of executing fixed business rules, the server dynamically constructs natural-language instructions that steer the generative model, and interprets outputs using structured mapping algorithms. This architecture yields technical effects including more efficient use of computational resources, reduction of communication overhead, and more accurate, timely delivery of information to the user terminal.

In another embodiment, the server deploys multiple generative AI models with differing capacities. The server may select a smaller model for low-latency scenarios and a larger model for high-accuracy scenarios based on device type, network conditions, or service tier.

The server may also cache intermediate context embeddings and prompt fragments to avoid recomputing common segments for successive requests from the same user.

In an alternative embodiment, the server stores the generative AI model and the emotion analysis model in separate accelerator devices such as graphics processing units. The processor distributes computation tasks among the accelerator devices by batching prompt sentences and emotion feature vectors, thereby increasing throughput and reducing latency for high-traffic environments. The server can also adjust generation parameters such as maximum token length and sampling temperature dynamically based on system load to maintain responsiveness.

The user terminal can be implemented as a mobile telephone, a tablet, or a desktop computer. The terminal may employ a native application or a web browser application. The terminal uses local processing resources to pre-process captured images and audio, for example by down-scaling resolution or compressing data, to reduce communication load. The terminal also manages local caching of recommendation lists and object images to allow instantaneous redisplay when the user navigates between screens, thereby further reducing server load and network traffic.

By combining behavior history information, emotion-related information, and current request information into a single prompt sentence for a generative AI model, and by mapping the model's output to concrete information objects stored in an information resource management apparatus, the server, the terminal, and the user cooperate in a technical process that improves the operation of the computer system itself. The system can be applied not only to product recommendation in an electronic commerce environment but also to recommendation of multimedia content, services, or other information objects, by adapting the information resource management apparatus and the definitions of behavior history information and emotion-related information. Multiple variations and modifications are possible: different neural network architectures, alternative emotion recognition models, and different prompt construction strategies can be used while preserving the core configuration in which the processor generates prompt sentences, invokes a generative AI model, interprets response information, and dynamically updates structured recommendation lists transmitted to user terminals.

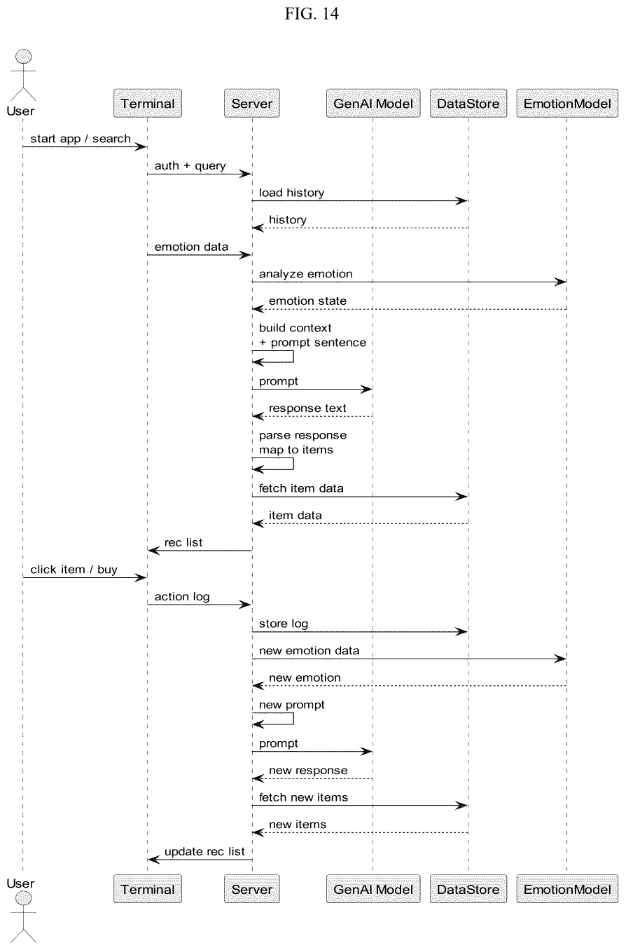

The following describes the processing flow using FIG. 14.

### Step 1:

The user operates the terminal to start an application and optionally logs in.

The terminal, as input, receives user credentials or an existing session token and device information.

The terminal performs authentication processing and session initialization, and as output, generates a session identifier and transmits the session identifier, user identifier, and device information to the server.

### Step 2:

The user inputs a current request, such as a search keyword or navigation command, into the terminal.

The terminal, as input, receives a text string (for example, “sneakers” or “outdoor gear”) and the current session identifier.

The terminal packages the text string and the session identifier into a structured request and, as output, transmits the request to the server via a network interface.

### Step 3:

The server receives the request from the terminal and parses the content.

The server, as input, accepts the structured request containing the user identifier, session identifier, and current request information.

The server uses a server-side framework to decode the request, extract the user identifier and the current request string, and as output, produces internal variables representing the user identifier and the current request for subsequent data processing.

### Step 4:

The server acquires behavior history information of the user from a database.

The server, as input, uses the user identifier obtained in Step 3.

The server executes database queries to retrieve records of search history, browsing history, interaction history, and transaction history associated with the user identifier, and as output, generates a behavior history dataset consisting of structured records including timestamps, object identifiers, categories, and numerical attributes.

### Step 5:

The server preprocesses the behavior history dataset into feature representations.

The server, as input, obtains the behavior history dataset from Step 4.

The server performs grouping by category and time ordering, computes aggregate statistics such as purchase counts and recency scores, normalizes numerical attributes, and encodes categorical attributes into indices and embedding vectors; as output, the server produces one or more feature vectors that characterize the user's long-term and short-term preferences.

### Step 6:

The terminal acquires emotion-related information from local sensors.

The terminal, as input, continuously captures image frames from a camera and audio signals from a microphone while the user interacts with the interface.

The terminal converts raw sensor signals into compressed digital image and audio data, associates them with timestamps, and as output, transmits the emotion-related data and timestamps to the server.

### Step 7:

The server estimates the emotion state of the user from the emotion-related data.

The server, as input, receives the compressed image and audio data and the associated timestamps from Step 6.

The server applies an emotion analysis model that performs operations such as face region extraction, feature map calculation, and spectrogram analysis to compute probabilities for multiple emotion categories; as output, the server determines a dominant emotion label and generates an emotion state representation, including at least one emotion label and corresponding probability values.

### Step 8:

The server constructs context information by combining behavior features, current request information, and emotion state.

The server, as input, uses the feature vectors from Step 5, the current request string from Step 3, and the emotion state representation from Step 7.

The server merges these components into a structured context object by associating statistics (for example, favorite categories), the current query text, and the dominant emotion label; as output, the server produces context information that is suitable for conversion into a natural-language description.

### Step 9:

The server generates a prompt sentence for a generative AI model based on the context information.

The server, as input, receives the structured context object from Step 8.

The server uses a prompt generation module to map feature fields to descriptive phrases, inserts them into a template, and concatenates them into a natural-language string; as output, the server produces a prompt sentence such as:
“Based on the user's past purchase history, please propose 3 products that the user is highly likely to buy next. The user often purchases sports goods and running shoes.”or
“The user has frequently purchased sneakers and sportswear. The current search keyword is ‘sneakers’. The current emotion is joy. Please propose 5 sneaker products that match this user's preferences and joyful mood.”

### Step 10:

The server invokes the generative AI model using the prompt sentence.

The server, as input, uses the prompt sentence from Step 9 and model configuration parameters such as maximum token length and generation randomness.

The server tokenizes the prompt sentence, feeds tokens into a transformer-type neural network or transmits the prompt to a remote generative AI service, and performs attention and feed-forward computations to generate output token distributions; as output, the server obtains response information in the form of generated text that describes one or more candidate information objects.

### Step 11:

The server interprets the response information and extracts candidate object attributes.

The server, as input, receives the generated response text from Step 10.

The server tokenizes the text, performs pattern matching and entity detection to identify names, categories, and attribute phrases, and resolves ambiguities by comparing extracted tokens with known attribute vocabularies; as output, the server produces a set of candidate object descriptions that each include attribute information such as object name, class, and descriptive features.

### Step 12:

The server maps candidate object descriptions to actual information object data stored in an information resource management apparatus.

The server, as input, receives the set of candidate object descriptions from Step 11.

The server issues search queries to the information resource management apparatus, performs exact or approximate matching on name and attribute fields, and computes similarity scores using string distance or embedding similarity; as output, the server obtains a collection of information object records that correspond to or closely approximate the candidate object descriptions.

### Step 13:

The server generates a structured recommendation list based on the matched information object records.

The server, as input, uses the matched records from Step 12 and preference signals from the feature vectors in Step 5.

The server ranks the objects by combining relevance measures from the generative AI model and preference measures from behavior features, assigns positions and visual emphasis flags, and organizes the objects into a list or grid representation; as output, the server produces a structured recommendation list data structure containing identifiers, display texts, media references, and ordering information.

### Step 14:

The server transmits the structured recommendation list to the terminal.

The server, as input, receives the structured recommendation list from Step 13 and session information from Step 3.

The server formats the recommendation list into a communication payload, associates it with the session identifier, and sends it through the network interface; as output, the terminal receives the payload as a response to its earlier request.

### Step 15:

The terminal renders the recommendation list on a user interface.

The terminal, as input, obtains the structured recommendation list payload from Step 14.

The terminal parses the payload into an internal display data structure, binds each information object to visual components such as cards or tiles, and draws these components on the display; as output, the terminal presents a visual layout of recommended objects with images, titles, prices, and control elements such as “Details” or “Buy” buttons.

### Step 16:

The user interacts with the recommended objects displayed on the terminal.

The user, as input, views the display and performs operations such as tapping a specific object card or scrolling the list.

The terminal captures the interaction events, associates them with object identifiers and timestamps, and as output, sends interaction logs (for example, clicks and selections) to the server for feedback and requests further details for the selected object.

### Step 17:

The server provides detailed information for a selected object and processes purchase-related actions.

The server, as input, receives an object identifier and an action type (for example, “view details” or “purchase”) from the terminal in Step 16.

The server retrieves detailed information object data from the information resource management apparatus, or initiates transaction processing when a purchase is requested, and as output, returns detailed data for display or confirmation data for a completed transaction.

### Step 18:

The server logs feedback and updates training data for future recommendation improvements.

The server, as input, receives interaction logs from Step 16 and transaction outcomes from Step 17.

The server stores these logs as additional behavior history records, aggregates them into training batches, and updates model training data structures; as output, the server prepares datasets that will be used to adjust neural network weights and prompt generation rules, thereby reducing future prediction error.

### Step 19:

The server monitors temporal changes in the user's emotion state and triggers prompt updates.

The server, as input, receives successive emotion state representations from repeated executions of Step 7.

The server compares current emotion probabilities with previous values, detects changes that exceed predetermined thresholds, and, upon detection, regenerates context information and a new prompt sentence that reflects the changed emotion; as output, the server produces an updated prompt sentence such as:
“The user's emotion has changed from joy to sadness while viewing running shoes. Please propose 3 alternative products that provide comfort or relaxation instead of performance-oriented items.”

### Step 20:

The server regenerates recommendations based on the updated prompt and provides real-time adaptation on the terminal.

The server, as input, uses the updated prompt sentence from Step 19.

The server repeats the invocation of the generative AI model, response interpretation, object mapping, and recommendation list generation as in Steps 10 through 13, but with the new context; as output, the server sends an updated structured recommendation list to the terminal, and the terminal replaces or augments the displayed recommendations so that the user sees recommendations that are adapted in real time to the user's current behavior and emotion state.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

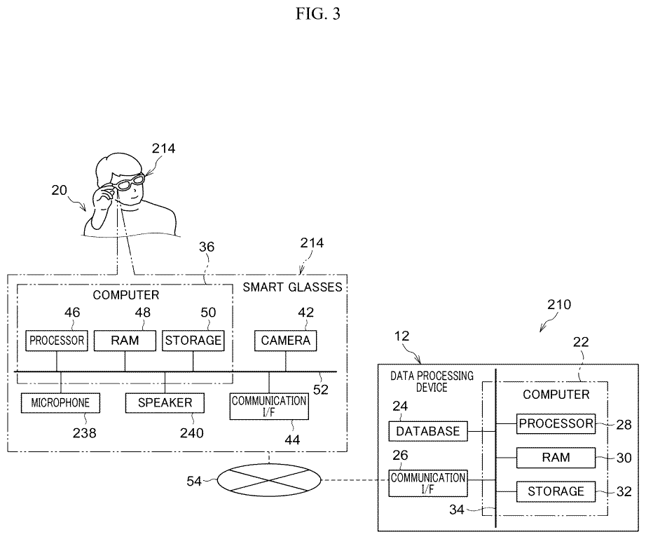

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

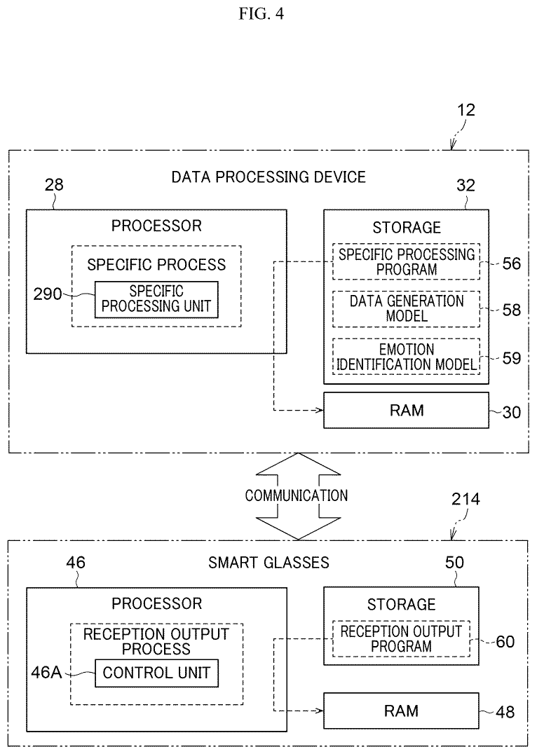

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

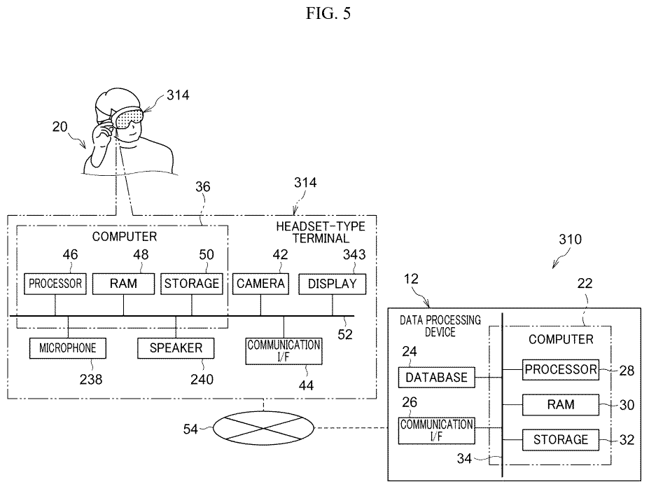

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

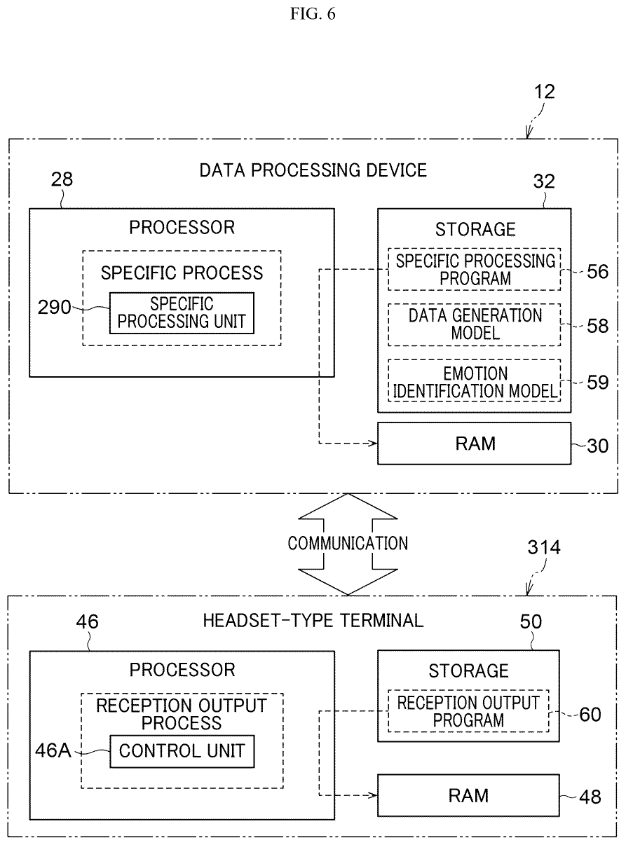

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

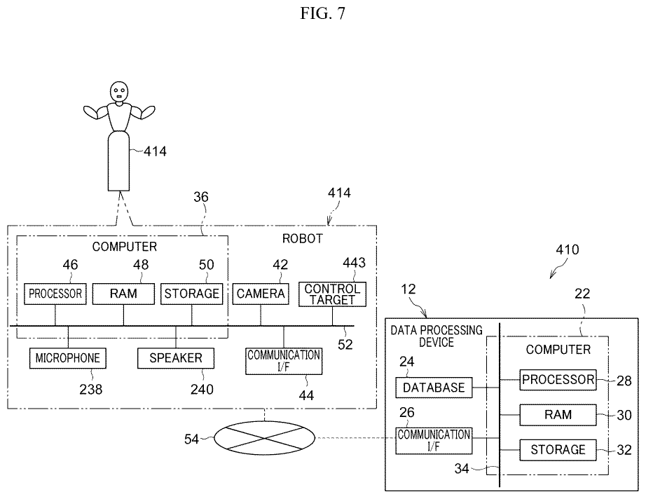

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

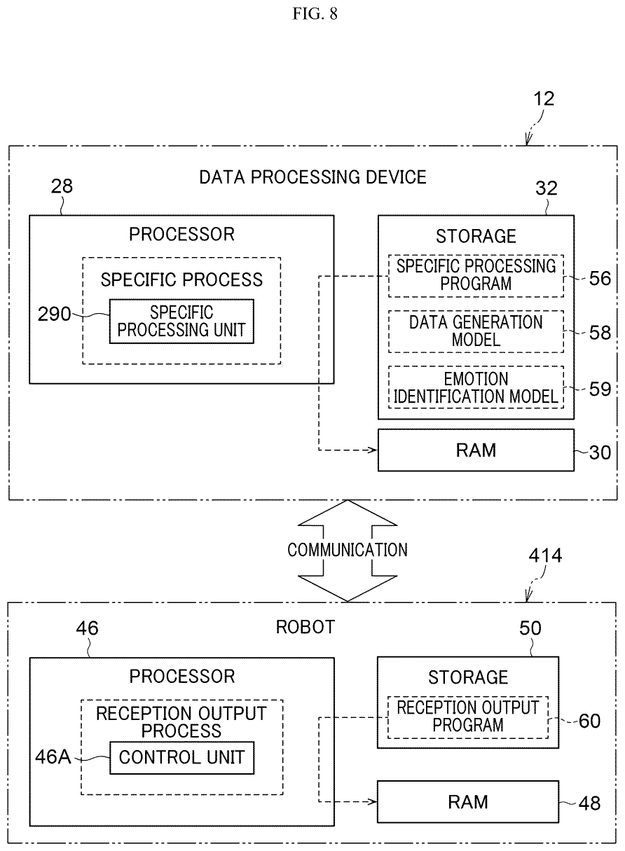

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

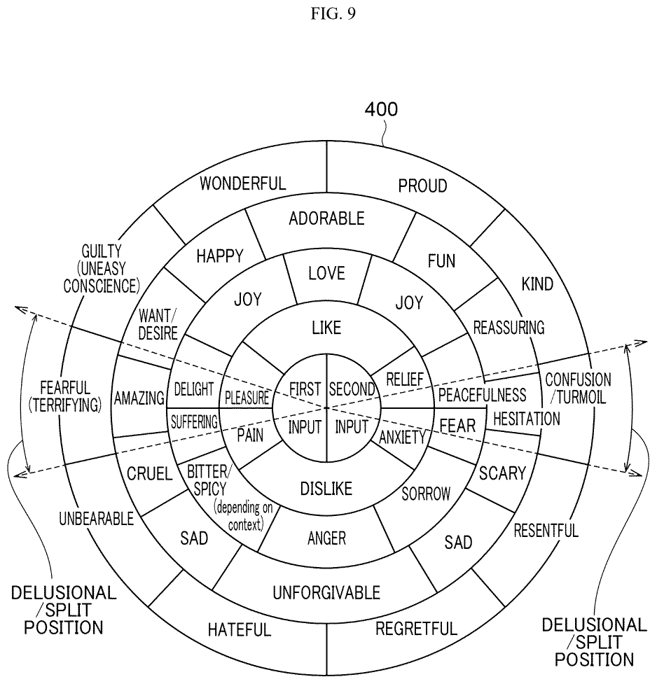

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

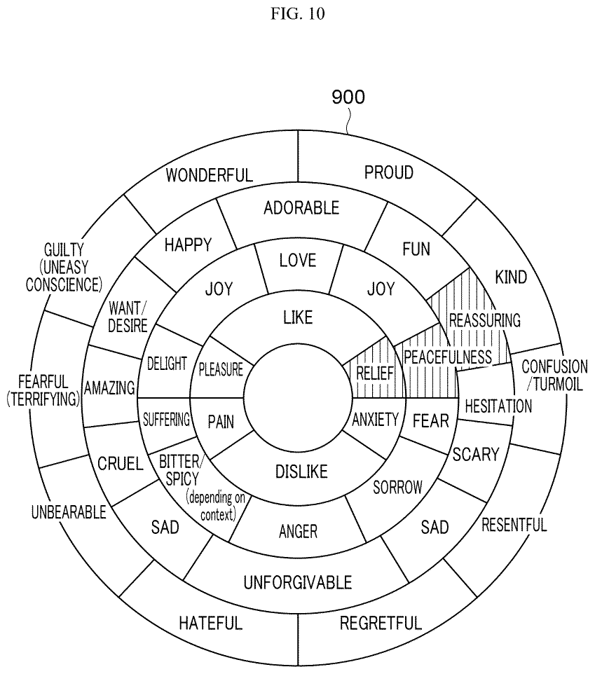

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

Example 1

### (Supplementary 1)

A system comprising a processor,
wherein the processor is configured to
acquire behavioral history information of a user by using an information processing apparatus and store the behavioral history information as recorded information in a storage medium, and
extract search history information and transaction history information from the recorded information, summarize an extraction result as a natural-language description, and generate a prompt sentence including the natural-language description together with an output format and processing conditions for a generative AI model, and
transmit the prompt sentence to the generative AI model, cause the generative AI model to generate recommendation target candidates having high relevance based on the prompt sentence, and obtain a generation result from the generative AI model, and
search a merchandise information recording medium based on name information or attribute information of the recommendation target candidates included in the generation result,
acquire item identification information, price information, and image information, and
integrate the acquired information as recommendation target information, and
transmit the recommendation target information to a user display device and cause the user display device to output, on a visual interface, a list of recommendation targets based on the recommendation target information.

### (Supplementary 2)

The system according to supplementary 1,
wherein the processor is configured to
select the search history information and the transaction history information in chronological order or based on importance, and include, in the prompt sentence, a summary of the selected history information, a condition regarding a number of recommendation targets, and an output data format.

### (Supplementary 3)

The system according to supplementary 1,
wherein the processor is configured to
assign, to each recommendation target candidate generated by the generative AI model, a relevance indicator or explanatory information, rank the recommendation target information based on the relevance indicator, and control display of the recommendation target information on the user display device according to the ranking.

### Application Example 1

### (Supplementary 1)

A system comprising a processor and a storage device,
wherein the processor is configured to
acquire, from the storage device that stores behavior history information of a user, search history information and purchase history information associated with the user,
convert the acquired search history information and purchase history information into tabular data by executing a data processing program, perform numerical computation on the tabular data to extract attribute information and preference information relating to the user, and
generate a prompt sentence in a natural language including at least part of the search history information and the purchase history information,
transmit the prompt sentence as input information to a generative AI model provided by an information processing apparatus, and obtain a generated result in the natural language from the generative AI model, the generated result including a plurality of candidate objects having a high degree of relevance to the user,
compare each of the plurality of candidate objects included in the generated result with product information stored in a product information storage device, identify product identification information corresponding to each candidate object, narrow down the plurality of candidate objects based on inventory information and supply condition information, and generate recommendation product information as structured data,
output, to a communication device, the recommendation product information together with display control information so that a mobile terminal receives the recommendation product information via a communication network and displays the recommendation product information in real time on a display unit of the mobile terminal, and
acquire, from the mobile terminal via the communication device, viewing information and selection operation information relating to the recommendation product information as behavior history information of the user, sequentially store the acquired viewing information and selection operation information in the storage device, and update contents of the prompt sentence based on the stored behavior history information so as to repeatedly transmit updated prompt sentences to the generative AI model.

### (Supplementary 2)

The system according to supplementary 1,
wherein the processor is configured to
generate the prompt sentence by extracting information within a predetermined period from among the search history information and the purchase history information, selecting keyword information and classification information based on at least one of occurrence frequency information and novelty information, and inserting an explanatory statement including the keyword information and the classification information into a template sentence.

### (Supplementary 3)

The system according to supplementary 1,
wherein the processor is configured to
generate the recommendation product information as the structured data by dividing the generated result in the natural language received from the generative AI model into a plurality of candidate object names by performing segmentation processing and character string analysis processing, associating each of the plurality of candidate object names with product information stored in the product information storage device by performing similarity calculation processing to identify the product identification information, and including, in the recommendation product information, at least the product identification information, price information, image reference information, and description information.

### Example 2

### (Supplementary 1)

A system comprising a processor,
wherein the processor is configured to
acquire behavioral history information from a storage area based on user identification information, and convert the acquired behavioral history information into aggregated history information including time information, classification information, and quantity information, to construct, in a natural language, a prompt sentence that instructs a generative AI model to select highly relevant candidate items based on the aggregated history information, and to transmit inquiry information including the prompt sentence and the aggregated history information to the generative AI model,
to receive, from the generative AI model, a plurality of recommendation candidate pieces of information generated based on the prompt sentence, to collate the recommendation candidate pieces of information with stored information so as to associate the recommendation candidate pieces of information with actual candidate items, and to format the associated candidate items as recommendation target information by adding inventory information, price information, and description information,
to transmit display information including the recommendation target information to a terminal device, and to cooperate with an interface that enables visual presentation of the recommendation target information on the terminal device, and
to process transaction request information received from the terminal device based on the recommendation target information, to generate a transaction record corresponding to the transaction request information, and to append the transaction record to the behavioral history information in the storage area.

### (Supplementary 2)

The system according to supplementary 1,
wherein the processor is configured to
acquire, as the behavioral history information, at least search history information and purchase history information, generate the aggregated history information including both the search history information and the purchase history information, and construct the prompt sentence based on the aggregated history information.

### (Supplementary 3)

The system according to supplementary 1,
wherein the processor is configured to
rank the recommendation candidate pieces of information according to an interest index based on reason information output by the generative AI model and the behavioral history information, organize the recommendation target information according to the ranking, and
generate display control information for visually presenting the recommendation target information via the interface.

### Application Example 2

### (Supplementary 1)

A system comprising a processor,
wherein the processor is configured to
acquire behavior history information of a user,
generate a prompt sentence based on the acquired behavior history information and current request information of the user, the prompt sentence being for instructing a generative information processing model to select one or more highly relevant information objects,
invoke the generative information processing model using the prompt sentence and obtain response information indicating the one or more highly relevant information objects from the generative information processing model,
analyze attribute information of candidate objects included in the response information and acquire corresponding information object data from an information resource management apparatus based on the attribute information,
generate a structured recommendation list including the acquired information object data and transmit the recommendation list to a user terminal,
analyze emotion-related information acquired from the user terminal and estimate an emotion state of the user, and
dynamically update the prompt sentence by combining the emotion state with the behavior history information and re-executing invocation processing of the generative information processing model so as to update the recommendation list in real time.

### (Supplementary 2)

The system according to supplementary 1,
wherein the processor is configured to
generate the prompt sentence by analyzing search history information and purchase history information of the user, extracting preference information from the search history information and the purchase history information, combining the preference information with the emotion state and the current request information of the user as context information, and converting the context information into a natural-language form.

### (Supplementary 3)

The system according to supplementary 1,
wherein the processor is configured to
generate and transmit the recommendation list by rearranging the candidate information objects selected by the generative information processing model based on the preference information and the emotion state of the user, generating a display data structure for visually presenting the candidate information objects, and providing the display data structure in a format suitable for presentation on an interactive user interface of the user terminal.

What is claimed is:

1. A system comprising:
circuitry configured to:
receive, from a terminal device via a communication interface coupled to a packet-switched network, event record data comprising interaction type data, identifier data, and timestamp data, normalize the event record data, and store the normalized event record data in a storage device as indexed history records;
retrieve, from the storage device based on a user identifier, a set of the indexed history records within a configurable time window, convert the set of indexed history records into tabular data structures, and compute feature data comprising frequency values, recency values derived from a time-decay function applied to the timestamp data, and aggregated preference scores for each of a plurality of category entries;
select representative entries from the feature data by ranking the category entries in descending order of the aggregated preference scores and retaining entries satisfying a score threshold, and construct a prompt data structure by embedding a natural-language summary of the representative entries into a template data structure together with output format constraints and candidate count parameters;
transmit the prompt data structure to the generative neural network model via the communication interface and receive generation result data comprising a plurality of candidate identifiers with associated confidence scores;
resolve the plurality of candidate identifiers against reference records stored in the storage device to obtain, for each candidate identifier, attribute data and status data, and integrate the attribute data and the status data into structured output data; and
transmit the structured output data to the terminal device via the communication interface and the packet-switched network.

2. The system according to claim 1, wherein the circuitry is configured to compute the recency values by applying an exponential decay function to a time difference between the timestamp data of each indexed history record and a current time reference, and to combine the recency values with the frequency values using a weighted summation to produce the aggregated preference scores.

3. The system according to claim 2, wherein the circuitry is configured to enforce diversity constraints when selecting the representative entries by comparing textual similarity between candidate entries and excluding entries having a similarity measure exceeding a deduplication threshold.

4. The system according to claim 3, wherein the circuitry is configured to generate the natural-language summary by concatenating the representative entries into a formatted text segment using a parameterized string template, and to append to the prompt data structure instruction clauses specifying a maximum number of candidate identifiers and a structured record format for the generation result data.

5. The system according to claim 4, wherein the circuitry is configured to validate the generation result data by parsing each candidate identifier against the structured record format, verifying conformance to the output format constraints, and discarding candidate identifiers having confidence scores below a relevance threshold.

6. The system according to claim 1, wherein the circuitry is configured to resolve the plurality of candidate identifiers by transmitting query data comprising attribute information extracted from the generation result data to the storage device, receiving matching reference records, and associating each matching reference record with a corresponding candidate identifier based on an identifier mapping.

7. The system according to claim 6, wherein the circuitry is configured to filter the plurality of candidate identifiers based on the status data indicating a current availability state of each reference record, and to exclude candidate identifiers for which the status data indicates an unavailable state.

8. The system according to claim 7, wherein the circuitry is configured to compute, for each remaining candidate identifier, a composite relevance score from the confidence scores generated by the generative neural network model and a recency factor derived from the indexed history records, and to sort the structured output data in descending order of the composite relevance score.

9. The system according to claim 1, wherein the circuitry is configured to estimate an emotional state of a user by applying an emotion analysis model to at least one of text input data and interaction pattern data received from the terminal device, and to modify the prompt data structure based on the estimated emotional state to adjust at least one of an output length parameter and a content priority parameter.

10. The system according to claim 9, wherein the circuitry is configured to re-transmit the modified prompt data structure to the generative neural network model to obtain updated generation result data reflecting the estimated emotional state, and to transmit updated structured output data to the terminal device.

11. The system according to claim 10, wherein the circuitry is configured to generate, for each candidate identifier in the structured output data, explanatory text data describing a correspondence between the candidate attribute data and the aggregated preference scores, and to transmit the explanatory text data to the terminal device.

12. The system according to claim 1, wherein the circuitry is configured to receive selection data from the terminal device indicating a user selection of at least one candidate identifier from the structured output data, generate a feedback record associating the selection data with the prompt data structure, and store the feedback record in the storage device as additional indexed history records.

13. The system according to claim 12, wherein the circuitry is configured to recompute the aggregated preference scores based on the feedback record by updating the frequency values and recency values for category entries associated with the selection data, and to incorporate the recomputed aggregated preference scores into a subsequent prompt data structure.

14. The system according to claim 1, wherein the circuitry is configured to acquire, from an external data source via the communication interface, supplementary reference records associated with the candidate identifiers, the supplementary reference records comprising descriptive text data, classification data, and numerical parameter data, and to merge the supplementary reference records into the structured output data.

15. The system according to claim 14, wherein the circuitry is configured to receive, from the terminal device, a request data indicating user intent to initiate a processing action on a selected candidate, transmit action request data to the external data source via the communication interface and the packet-switched network, and receive confirmation data indicating completion of the processing action.

16. The system according to claim 1, wherein the circuitry is configured to acquire image data associated with the candidate identifiers from the storage device, generate display control data comprising the image data, the attribute data, and the confidence scores formatted for a graphical interface, and transmit the display control data to the terminal device.

17. The system according to claim 1, wherein the circuitry is configured to periodically retrieve updated indexed history records from the storage device, detect changes in the aggregated preference scores relative to previously stored preference scores, and regenerate the prompt data structure based on the detected changes to obtain updated candidate identifiers from the generative neural network model.

18. A system comprising:
circuitry configured to:
receive, from a terminal device via a communication interface coupled to a packet-switched network, event record data and store the event record data in a storage device as indexed history records;
retrieve the indexed history records, convert the indexed history records into tabular data structures, and compute feature data comprising frequency values, recency values derived from a time-decay function, and aggregated preference scores;
select representative entries from the feature data based on the aggregated preference scores and construct a prompt data structure comprising a natural-language summary of the representative entries and output format constraints;
transmit the prompt data structure to the generative neural network model and receive generation result data comprising candidate identifiers with confidence scores;
resolve the candidate identifiers against reference records stored in the storage device to obtain attribute data and status data, and integrate the attribute data and the status data into structured output data;
estimate an emotional state of a user based on data received from the terminal device and modify the prompt data structure based on the estimated emotional state; and
transmit the structured output data to the terminal device via the communication interface and the packet-switched network.

19. The system according to claim 18, wherein the circuitry is configured to receive selection data from the terminal device, store the selection data as additional indexed history records in the storage device, recompute the aggregated preference scores, and incorporate the recomputed scores into a subsequent prompt data structure.

20. A method performed by circuitry, the method comprising:
receiving, from a terminal device via a communication interface coupled to a packet-switched network, event record data comprising interaction type data, identifier data, and timestamp data, normalizing the event record data, and storing the normalized event record data in a storage device as indexed history records;
retrieving, from the storage device based on a user identifier, a set of the indexed history records, converting the set of indexed history records into tabular data structures, and computing feature data comprising frequency values, recency values derived from a time-decay function applied to the timestamp data, and aggregated preference scores;
selecting representative entries from the feature data by ranking in descending order of the aggregated preference scores and constructing a prompt data structure comprising a natural-language summary of the representative entries and output format constraints;
transmitting the prompt data structure to a generative neural network model and receiving generation result data comprising candidate identifiers with confidence scores;
resolving the candidate identifiers against reference records stored in the storage device to obtain attribute data and status data, and integrating the attribute data and the status data into structured output data; and
transmitting the structured output data to the terminal device via the communication interface and the packet-switched network.
